(19) United States
(12) Patent Application Publication
(10) Pub. No.: US 2021/0216134 A1
(43) Pub. Date: Jul. 15, 2021

(54) INFORMATION PROCESSING APPARATUS AND METHOD, AND PROGRAM

(71) Applicant: Sony Corporation, Tokyo (JP)

(72) Inventors: Daisuke Fukunaga, Tokyo (JP); Yoshiki Tanaka, Kanagawa (JP); Hisahiro Suganuma, Tokyo (JP); Yuji Nishimaki, Tokyo (JP)

(73) Assignee: Sony Corporation, Tokyo (JP)

(21) Appl. No.: 17/058,931

(22) PCT Filed: May 23, 2019
(86) PCT No.: PCT/JP2019/020380

§ 371 Date: Nov. 25, 2020

(30) Foreign Application Priority Data
Jun. 6, 2018 (JP) 2018-108330

(51) Int. Cl. G06F 3/01; G06F 3/16; G06T 7/73; G10L 25/84

(52) U.S. Cl. CPC G06F 3/011; G10L 25/84; G06T 7/73; G06F 3/167

(57) ABSTRACT

The present technology relates to an information processing apparatus, an information processing method, and a program capable of achieving more appropriate sound recognition execution control.

The information processing apparatus includes a control unit that ends a sound input reception state on the basis of user direction information indicating a direction of a user. The present technology is applicable to a sound recognition system.

### TECHNICAL FIELD

The present technology relates to an information processing apparatus, an information processing method, and a program, and particularly to an information processing apparatus, an information processing method, and a program capable of achieving more appropriate sound recognition execution control.

### BACKGROUND ART

Some types of dialog type agent system having a sound recognition function each set a trigger for starting the sound recognition function to prevent malfunction of sound recognition in response to self-talk of a user, ambient noise, and the like.

Typical examples of methods for starting the sound recognition function using a trigger include a method which starts sound recognition in a case where a specific starting word determined beforehand is uttered, and a method which receives sound input only when a button is pressed. However, these methods require uttering of the starting word or a press of the button every time a dialog starts, and therefore impose a burden on the user.

Meanwhile, there has been also proposed a method which determines whether to start a dialog according to a trigger which is a direction of a visual line or a face of a user (e.g., see PTL 1). This technology allows the user to easily start a dialog with a dialog type agent without the necessity of uttering the starting word or pressing the button.

### CITATION LIST

### Patent Literature

### [PTL 1]

JP 2014-92627 A

### SUMMARY

### Technical Problem

However, the technology described in PTL 1 which uses only visual line information at a certain time may cause erroneous detection.

For example, in a case where the visual line or the face of the user is temporarily directed to the dialog type agent by accident during conversation between humans without intention of talking to the dialog type agent, the dialog type agent starts the sound recognition function against the intention of the user, and returns a response.

Accordingly, appropriate execution control of sound recognition and reduction of malfunction of the sound recognition function are difficult to achieve by the technology described above.

The present technology has been developed in consideration of such circumstances, and achieves more appropriate sound recognition execution control.

### Solution to Problem

An information processing apparatus according to one aspect of the present technology includes a control unit that ends a sound input reception state on the basis of user direction information indicating a direction of a user.

An information processing method or a program according to one aspect of the present technology includes a step of ending a sound input reception state on the basis of user direction information indicating a direction of a user.

According to one aspect of the present technology, a sound input reception state is ended on the basis of user direction information indicating a direction of a user.

### Advantageous Effects of Invention

According to one aspect of the present technology, more appropriate sound recognition execution control is achievable.

Note that advantageous effects to be produced are not limited to the advantageous effects described herein, but may be any advantageous effects described in the present disclosure.

### BRIEF DESCRIPTION OF DRAWINGS

FIG. 1 is a diagram depicting a configuration example of a sound recognition system.

FIG. 2 is a diagram explaining sound section detection.

FIG. 3 is a diagram depicting a control example of a start and an end of input of detected sound information.

FIG. 4 is a diagram depicting a control example of a start and an end of input of detected sound information.

FIG. 5 is a diagram depicting a control example of a start and an end of input of detected sound information.

FIG. 6 is a diagram depicting a control example of a start and an end of input of detected sound information.

FIG. 7 is a diagram depicting a control example of a start and an end of input of detected sound information.

FIG. 8 is a flowchart explaining an input reception control process.

FIG. 9 is a flowchart explaining a sound recognition execution process.

FIG. 10 is a diagram depicting a configuration example of a sound recognition system.

FIG. 11 is a diagram depicting an input example of detected sound information.

FIG. 12 is a diagram depicting an input example of detected sound information.

FIG. 13 is a diagram depicting a configuration example of a sound recognition system.

FIG. 14 is a flowchart explaining an update process.

FIG. 15 is a diagram depicting a control example of a start and an end of input of detected sound information.

FIG. 16 is a diagram depicting a control example of a start and an end of input of detected sound information.

FIG. 17 is a diagram explaining an end of a sound input reception state.

FIG. 18 is a diagram explaining an end of the sound input reception state.

FIG. 19 is a diagram depicting a display example in a case where a visual line is shifted from an input reception visual line position.

FIG. 20 is a diagram depicting a display example in a case where a visual line is shifted from an input reception visual line position.

FIG. 21 is a diagram depicting a configuration example of a sound recognition system.

FIG. 22 is a flowchart explaining an input reception control process.

FIG. 23 is a diagram depicting a configuration example of a sound recognition system.

FIG. 24 is a flowchart explaining a sound recognition execution process.

FIG. 25 is a diagram depicting a configuration example of a sound recognition system.

FIG. 26 is a diagram depicting a configuration example of a sound recognition system.

FIG. 27 is a diagram depicting a presentation example which indicates users directing visual lines.

FIG. 28 is a diagram explaining a linkage example with other apparatuses.

FIG. 29 is a diagram depicting a configuration example of a computer.

### DESCRIPTION OF EMBODIMENTS

Embodiments to which the present technology is applied will be hereinafter described with reference to the drawings.

### First Embodiment

### <Configuration Example of Sound Recognition System>

The present technology achieves appropriate sound recognition execution control by establishing a sound input receiving state or ending the sound input receiving state on the basis of directions of a visual line, a face, or a body of a user, or a combination of these directions, i.e., on the basis of user direction information indicating a direction of the user. Particularly, the present technology is capable of more accurately starting or ending a sound recognition function by use of real-time user direction information.

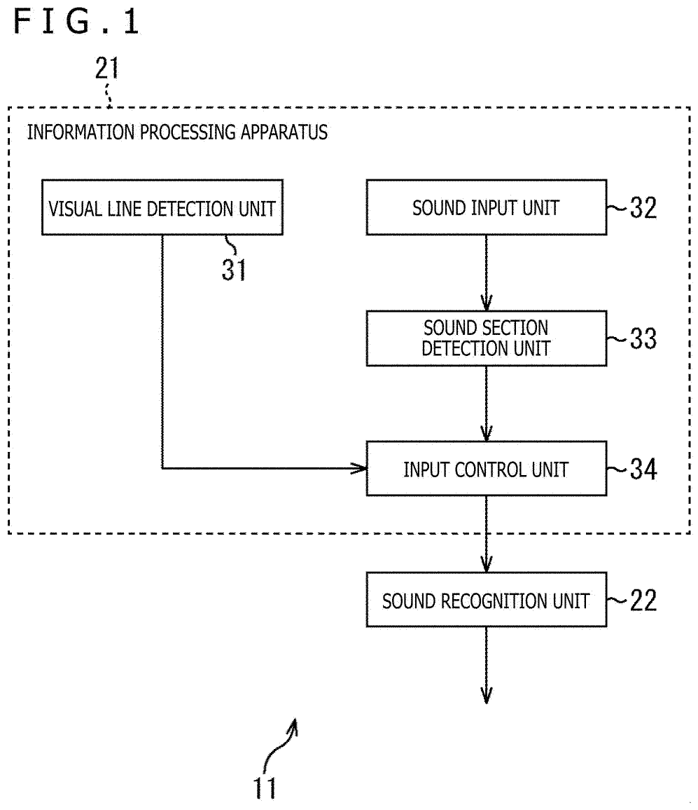

FIG. 1 is a diagram depicting a configuration example of a sound recognition system according to one embodiment to which the present technology is applied.

A sound recognition system 11 depicted in FIG. 1 includes an information processing apparatus 21 and a sound recognition unit 22. Moreover, the information processing apparatus 21 includes a visual line detection unit 31, a sound input unit 32, a sound section detection unit 33, and an input control unit 34.

According to a configuration of this example, the information processing apparatus 21 is an apparatus or the like operated by a user, such as a smart speaker and a smartphone, for example, while the sound recognition unit 22 is provided on a server or the like connected to the information processing apparatus 21 via a wired or wireless network.

Note that configurations also adaptable are such a configuration where the sound recognition unit 22 is provided on the information processing apparatus 21, and such a configuration where the visual line detection unit 31 and the sound input unit 32 are not provided on the information processing apparatus 21. In addition, also adoptable is such a configuration where the sound section detection unit 33 is provided on a server or the like connected via a network.

The visual line detection unit 31 includes a camera or the like, for example, and generates visual line information as user direction information by detecting a visual line direction of the user, and supplies the generated visual line information to the input control unit 34. Specifically, the visual line detection unit 31 detects a direction of a visual line of the user located around, more specifically, a place to which the visual line of the user is directed, on the basis of an image captured by the camera, and outputs a detection result thus obtained as visual line information.

While the visual line detection unit 31 and the sound input unit 32 are provided on the information processing apparatus 21 herein, the visual line detection unit 31 may be incorporated in a device where the sound input unit 32 is provided, or may be provided on a device different from the device where the sound input unit 32 is provided.

In addition, while the example described herein is an example where the user direction information is visual line information, the visual line detection unit 31 may detect a direction of the face of the user or the like on the basis of a depth image, and use a detection result thus obtained as the user direction information.

For example, the sound input unit 32 includes one or a plurality of microphones, and receives input of ambient sound. Specifically, the sound input unit 32 collects ambient sound, and supplies a sound signal thus obtained to the sound section detection unit 33 as input sound information. Sound collected by the sound input unit 32 will be hereinafter also referred to as input sound.

The sound section detection unit 33 detects a section where the user actually gives an utterance as an utterance section from input sound on the basis of input sound information supplied from the sound input unit 32, and supplies detected sound information obtained by cutting out the utterance section from the input sound information to the input control unit 34. Sound in the utterance section of the input sound, i.e., sound in an actual utterance portion of the user will be hereinafter also particularly referred to as detected sound.

The input control unit 34 controls reception of input of the detected sound information supplied from the sound section detection unit 33 to the sound recognition unit 22, i.e., input of detected sound information for sound recognition on the basis of the visual line information supplied from the visual line detection unit 31.

For example, the input control unit 34 defines a sound input reception state as a state where sound input is received to perform sound recognition at the sound recognition unit 22.

According to the embodiment, the sound input reception state is a state where input of detected sound information is received, i.e., a state where supply (input) of detected sound information to the sound recognition unit 22 is allowed.

The input control unit 34 establishes the sound input reception state or ends the sound input reception state on the basis of the visual line information supplied from the visual line detection unit 31. In other words, a start and an end of the sound input reception state is controlled.

In response to a transition to the sound input reception state, i.e., a start of the sound input reception state, the input control unit 34 supplies the received detected sound information to the sound recognition unit 22. When the sound input reception state ends, the input control unit 34 stops supply of the detected sound information to the sound recognition unit 22 even with continuation of supply of the detected sound information. In this manner, the input control unit 34 controls execution of sound recognition at the sound recognition unit 22 by controlling the input start and end of the detected sound information to the sound recognition unit 22.

The sound recognition unit 22 performs sound recognition for the detected sound information supplied from the input control unit 34, converts the detected sound information into detected sound text information, and outputs the obtained text information.

### <Start and End of Sound Recognition>

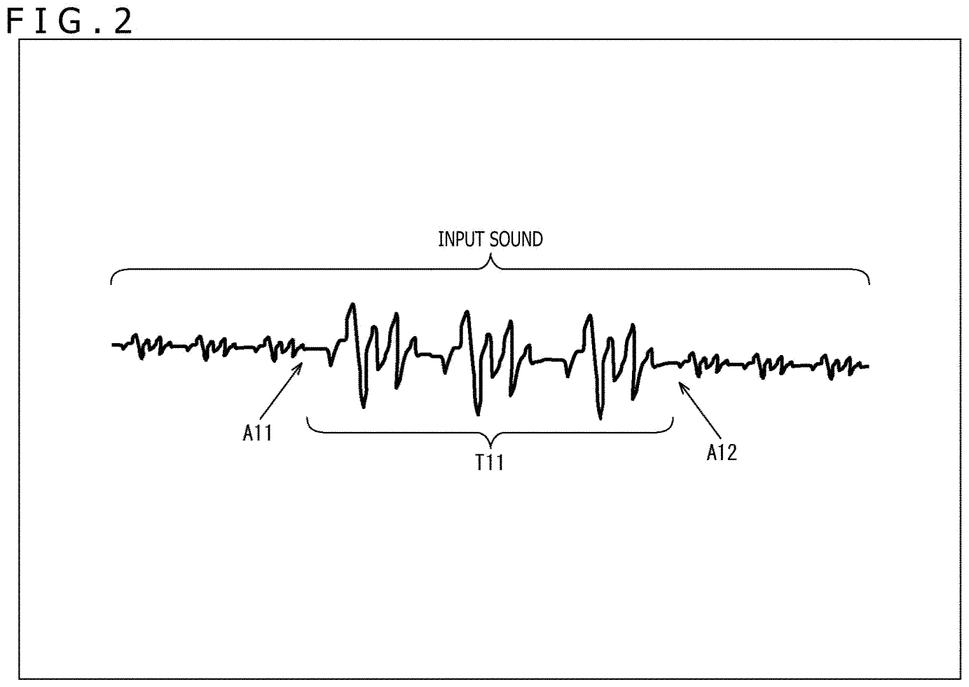

Meanwhile, the sound section detection unit 33 detects an utterance section on the basis of sound pressure of input sound information. For example, in a case where input sound depicted in FIG. 2 is supplied, a section T11 from a start end A11 to a terminal end A12, where sound pressure level is higher than in other sections, is detected as an utterance section. Thereafter, a portion corresponding to the section T11 is supplied as detected sound information from the sound section detection unit 33 to the input control unit 34.

The input control unit 34 controls reception of input of detected sound information on the basis of visual line information.

Specifically, when the visual line of the user is directed to a specific place determined beforehand, for example, the input control unit 34 establishes the sound input reception state, and starts reception of input of detected sound information to the sound recognition unit 22.

Note that only reception of input of the detected sound information is started at this time. The detected sound information is actually supplied to the sound recognition unit 22 at timing when an utterance section is detected by the sound section detection unit 33.

In addition, the specific place herein refers to a device or the like, such as the information processing apparatus 21 equipped with the sound input unit 32, for example. The specific place (position) for which the sound input reception state is established when the visual line of the user is directed to the specific place will be hereinafter particularly also referred to as an input reception visual line position.

The information processing apparatus 21 continuously collects sound using the sound input unit 32 regardless of whether the sound input reception state is established or not. The sound section detection unit 33 also continuously detects an utterance section.

Moreover, the visual line detection unit 31 continuously detects a visual line even while the user is giving an utterance. The sound input reception state is continuously established as long as the user continues to direct the visual line to the input reception visual line position. The sound input reception state ends when the visual line of the user shifts from the input reception visual line position.

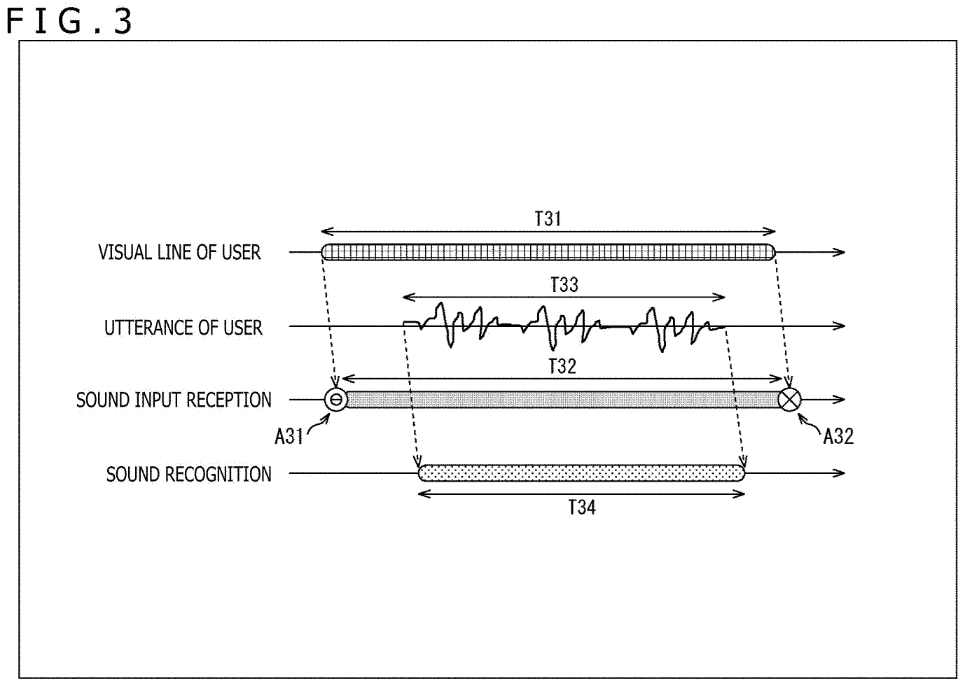

Control examples of a start and an end of input of detected sound information will be herein described with reference to FIGS. 3 to 7. Note that a horizontal direction indicates a time direction in each of FIGS. 3 to 7.

For example, in an example presented in FIG. 3, a period T31 indicates a period in which the visual line of the user is directed to an input reception visual line position. Accordingly, the sound input reception state is established at timing (time) indicated by an arrow A31 which is timing immediately after a start of the period T31, while the sound input reception state is ended at timing (time) indicated by an arrow A32 which is timing immediately after an end of the period T31. In other words, the sound input reception state is continuously established during a period T32 which is a period substantially equivalent to the period T31.

Moreover, according to this example, an utterance section T33 is detected from input sound within the period T32 for which the sound input reception state is established. Accordingly, an entire portion corresponding to the utterance section T33 in input sound information is supplied to the sound recognition unit 22 as detected sound information to perform sound recognition. In other words, sound recognition is continuously performed in a period T34 corresponding to the utterance section T33 herein, and a recognition result thus obtained is output.

As described above, according to the sound recognition system 11, a part after a start end of utterance of the user is supplied to the sound recognition unit 22 as detected sound information when the start end of the utterance is detected by the sound section detection unit 33 in a state where the sound input reception state is established. A process for supplying detected sound information to the sound recognition unit 22 starts simultaneously with utterance of the user in real time, and continues until detection of a terminal end of the utterance of the user by the sound section detection unit 33 unless the sound input reception state is ended.

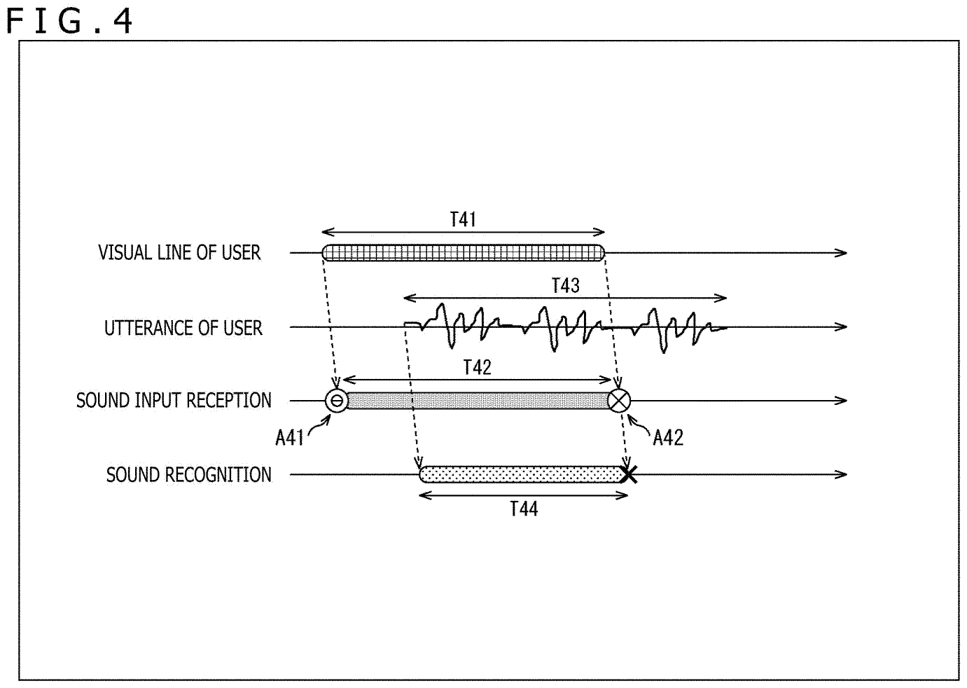

Moreover, in an example presented in FIG. 4, a period T41 indicates a period in which the visual line of the user is directed to the input reception visual line position. Accordingly, the sound input reception state is established at timing indicated by an arrow A41 which is timing immediately after a start of the period T41, and the sound input reception state is ended at timing indicated by an arrow A42 which is timing immediately after an end of the period T41. In other words, the sound input reception state is continuously established during a period T42.

According to this example, a start end of an utterance section T43 is detected from input sound within the period T42 for which the sound input reception state is established. However, a terminal end of the utterance section T43 is timing out of the period T42.

The sound section detection unit 33 defines the detected sound information as a portion after the start end of the utterance section T43 in the input sound information. Thereafter, supply of the detected sound information to the sound recognition unit 22 starts. The sound input reception state ends before detection of the terminal end of the utterance section T43, and supply of the detected sound information to the sound recognition unit 22 is suspended. In other words, sound recognition is performed herein in a period T44 corresponding to a part of the period of the utterance section T43. The process of sound recognition performed by the sound recognition unit 22 is suspended (cancelled) along with the end of the sound input reception state.

In a case where the visual line of the user is directed to a position different from the input reception visual line position after establishment of the sound input reception state based on the visual line of the user directed to the input reception visual line position, the sound input reception state ends at that time. In addition, the sound recognition process is suspended even during an utterance by the user. It is therefore possible to prevent such malfunction that dialog or the like with the user is started on the basis of sound recognition performed by the sound recognition function of the sound recognition system 11 against an intention of a start of this function, such as a case where the visual line of the user is accidentally directed to the input reception visual line position during conversation with other users.

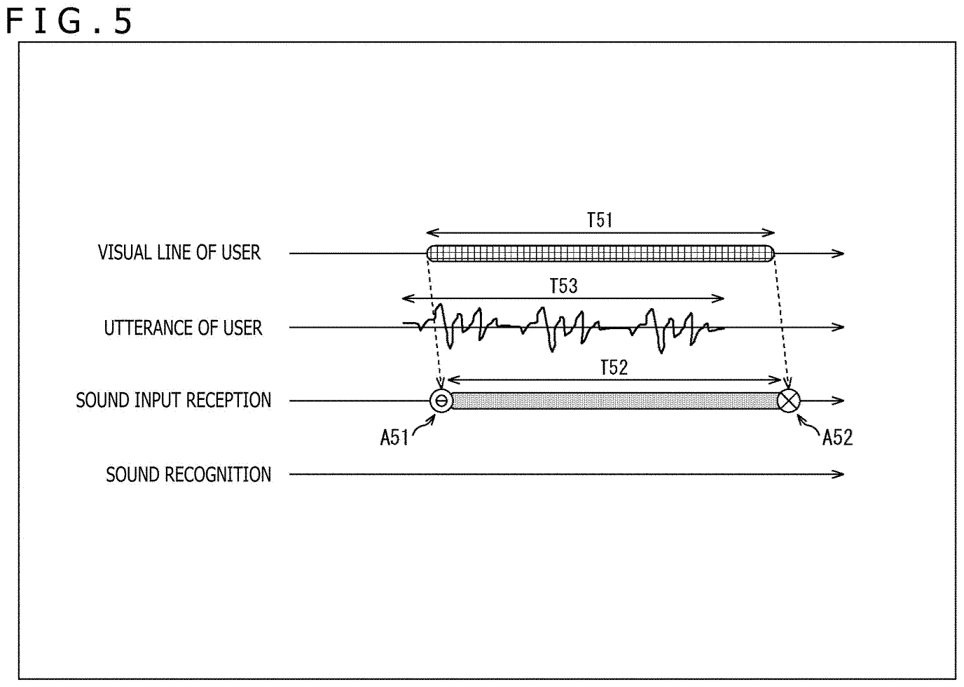

According to an example presented in FIG. 5, a period T51 indicates a period in which the visual line of the user is directed to the input reception visual line position. Accordingly, the sound input reception state is established at timing indicated by an arrow A51 immediately after a start of the period T51, and the sound input reception state is ended at timing indicated by an arrow A52 immediately after an end of the period T51. In other words, the sound input reception state is continuously established during a period T52.

According to this example, a period partially included in the period T52 is detected as an utterance section T53. A start end of the utterance section T53 is detected, in terms of time, at timing before the timing indicated by the arrow A51 for which the sound input reception state is established. Accordingly, a portion corresponding to the utterance section T53 of the input sound information is not supplied to the sound recognition unit 22, and sound recognition is not performed for this portion. In other words, sound recognition is not performed in a case where the start end of the utterance section T53 is not detected within the period for which the sound input reception state is established.

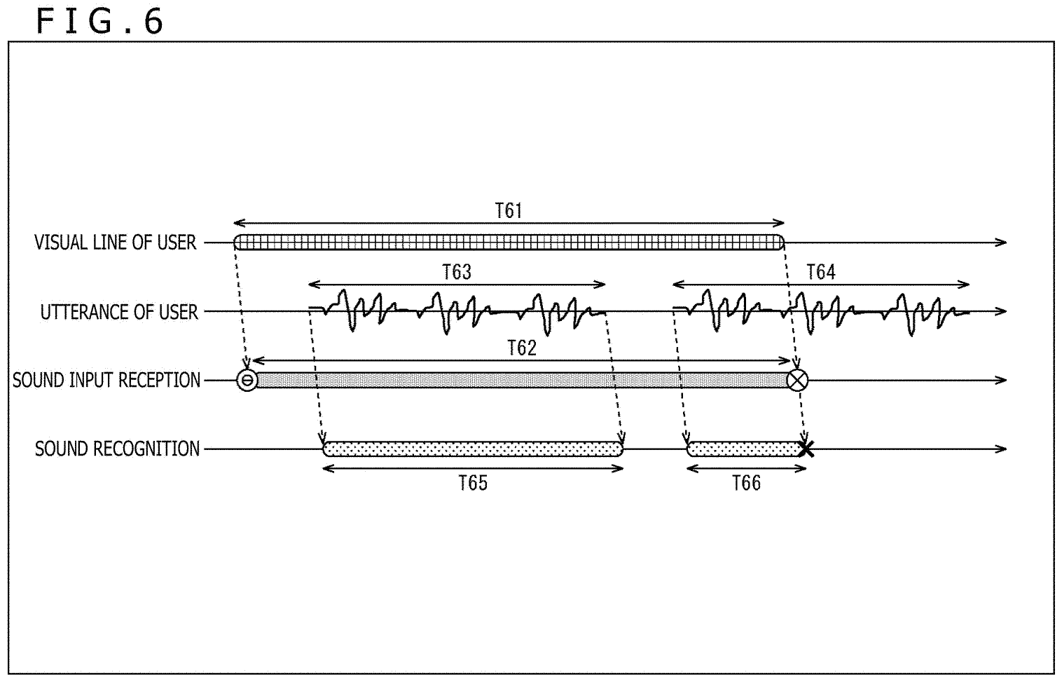

According to an example presented in FIG. 6, a period T61 indicates a period in which the visual line of the user is directed to the input reception visual line position, while a period T62 indicates a period for which the sound input reception state is established. According to this example, two utterance sections including an utterance section T63 and an utterance section T64 are detected from input sound information.

The whole of the utterance section T63 is herein included in the period T62 for which the sound input reception state is established. Accordingly, a portion corresponding to the utterance section T63 in input sound information is supplied to the sound recognition unit 22 as detected sound information to perform sound recognition. In other words, sound recognition is continuously performed in a period T65 corresponding to the utterance section T63, and a recognition result thus obtained is output.

On the other hand, as for the utterance section T64, a start end portion of the utterance section T64 is included in the period T62, but a terminal end portion of the utterance section T64 is not included in the period T62. In other words, the user shifts the visual line from the input reception visual line position in the middle of an utterance corresponding to the utterance section T64.

Accordingly, a portion after the start end of the utterance section T64 in the input sound information is supplied to the sound recognition unit 22 as detected sound information. This supply of the detected sound information is suspended at the timing of the terminal end of the period T62. Specifically, sound recognition is performed herein in a period T66 corresponding to a part of the period of the utterance section T64. The process of sound recognition is suspended (cancelled) along with the end of the sound input reception state.

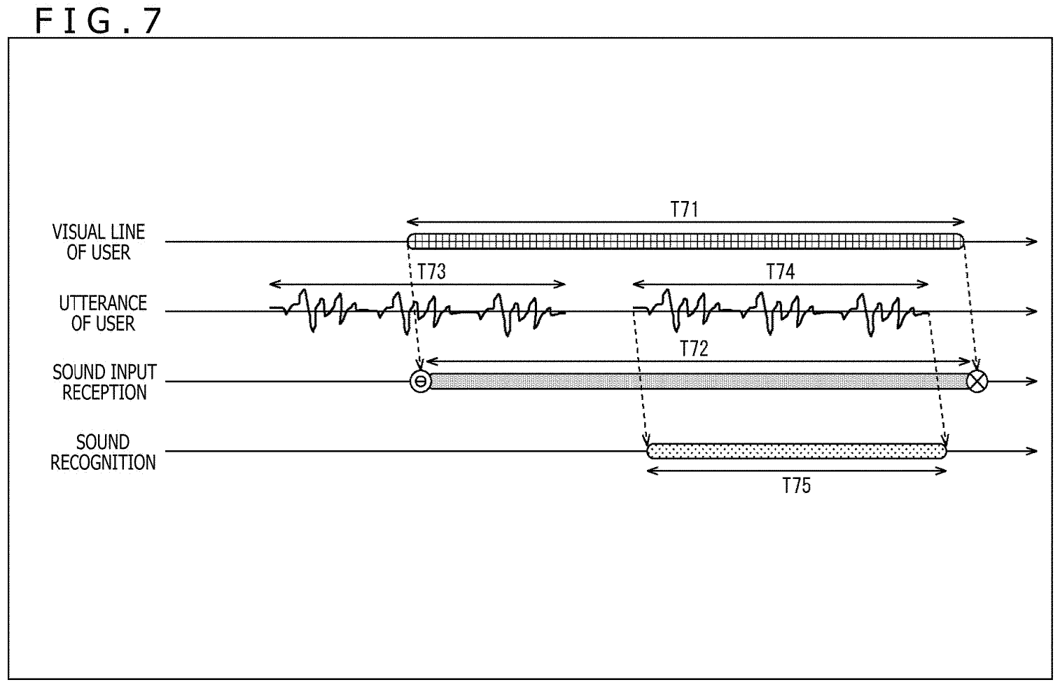

According to an example presented in FIG. 7, a period T71 indicates a period in which the visual line of the user is directed to the input reception visual line position, while a period T72 indicates a period for which the sound input reception state is established. According to this example, two utterance sections including an utterance section T73 and an utterance section T74 are detected from input sound information.

As for the first utterance section T73 herein, a start end of the utterance section T73 is detected at timing before a start end of the period T72 for which the sound input reception state is established. Accordingly, similarly to the example presented in FIG. 5, a portion corresponding to the utterance section T73 in the input sound information is not supplied to the sound recognition unit 22, and sound recognition is not performed.

On the other hand, as for the second utterance section T74, the whole of the utterance section T74 is included in the period T72 for which the sound input reception state is established. Accordingly, a portion corresponding to the utterance section T74 in the input sound information is supplied to the sound recognition unit 22 as detected sound information to perform sound recognition. In other words, sound recognition is continuously performed in a period T75 corresponding to the utterance section T74.

As presented in the examples of FIGS. 6 and 7, when the user gives a subsequent utterance while maintaining the visual line directed to the input reception visual line position after detection of a terminal end of an utterance (utterance section) of the user in a state where the visual line of the user is directed to the input reception visual line position, the subsequent utterance becomes a target of sound recognition.

As described above, the present technology achieves more appropriate sound recognition execution control by continuously establishing the sound input reception state while the user is directing the visual line to the input reception visual line position.

Particularly, the sound input reception state ends at the time when the user shifts the visual line from the input reception visual line position. Accordingly, continuous sound recognition is avoidable even in a case where the user unintentionally directs the visual line to the input reception visual line position. Appropriate sound recognition execution control is therefore achievable as in the examples presented in FIGS. 4 and 6, for example. Moreover, even in a case where the user gives a plurality of utterances as in the examples of FIGS. 6 and 7, sound recognition is only performed for the utterance given with the visual line of the user directed to the input reception visual line position in the plurality of utterances.

### <Description of Input Reception Control Process>

An operation of the sound recognition system 11 will be subsequently described.

For example, during operation of the sound recognition system 11, the sound recognition system 11 simultaneously performs an input reception control process for controlling reception of sound input, and a sound recognition execution process for performing sound recognition for input sound.

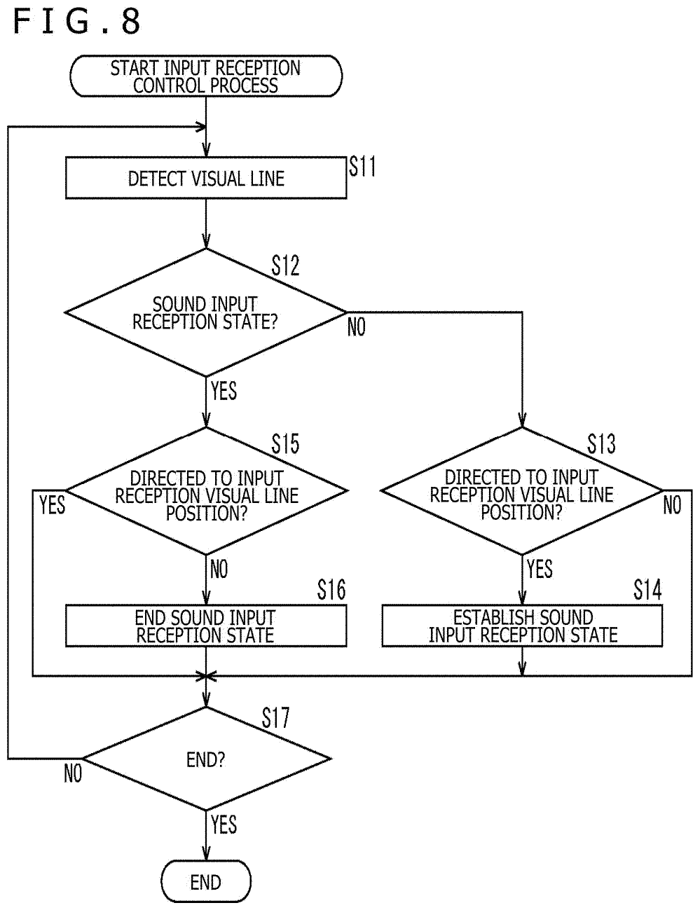

The input reception control process performed by the sound recognition system 11 will be initially described with reference to a flowchart in FIG. 8.

In step S11, the visual line detection unit 31 detects a visual line, and supplies visual line information obtained as a result of the detection to the input control unit 34.

In step S12, the input control unit 34 determines whether or not the sound input reception state has been established.

In the case of determination that the sound input reception state is not established in step S12, the input control unit 34 in step S13 determines whether or not the visual line of the user is directed to an input reception visual line position on the basis of the visual line information supplied from the visual line detection unit 31. Specifically, for example, it is determined whether or not the visual line direction of the user indicated in the visual line information is a direction of the input reception visual line position.

In the case of determination that the visual line is not directed to the input reception visual line position in step S13, the state other than the sound input reception state is maintained. Thereafter, the process proceeds to step S17.

On the other hand, in the case of determination that the visual line is directed to the input reception visual line position in step S13, the input control unit 34 in step S14 establishes the sound input reception state. After completion of processing in step S14, the process proceeds to step S17.

Moreover, in the case of determination that the sound input reception state has been established in step S12, the input control unit 34 in step S15 determines whether or not the visual line of the user is directed to the input reception visual line position on the basis of the visual line information supplied from the visual line detection unit 31.

In the case of determination that the visual line is directed to the input reception visual line position in step S15, the sound input reception state is maintained on the basis of continuation of the visual line of the user directed to the input reception visual line position. Thereafter, the process proceeds to step S17.

On the other hand, in the case of determination that the visual line is not directed to the input reception visual line position in step S15, the input control unit 34 in step S16 ends the sound input reception state on the basis of a shift of the visual line of the user from the input reception visual line position. After completion of processing in step S16, the process proceeds to step S17.

Processing in step S17 is performed in response to determination that the visual line is not directed to the input reception visual line position in step S13, completion of processing in step S14 or S16, or determination that the visual line is directed to the input reception visual line position in step S15.

In step S17, the input control unit 34 determines whether to end the process. For example, in a case where an instruction for operation stop of the sound recognition system 11 is issued, an end of the process is determined in step S17.

In a case where an end of the process is not determined in step S17, the process returns to step S11 to repeat the processing described above.

On the other hand, in a case where an end of the process is determined in step S17, operations of respective units of the sound recognition system 11 are stopped, and the input reception control process ends.

In the manner described above, the sound recognition system 11 continues the sound input reception state while the visual line of the user is directed to the input reception visual line position. When the visual line of the user is shifted from the input reception visual line position, the sound recognition system 11 ends the sound input reception state.

In this manner, more appropriate sound recognition execution control is achievable by controlling the start and the end of the sound input reception state on the basis of user visual line information. Accordingly, reduction of malfunction of the sound recognition function, and improvement of usability of the sound recognition system 11 are realizable.

### <Description of Sound Recognition Execution Process>

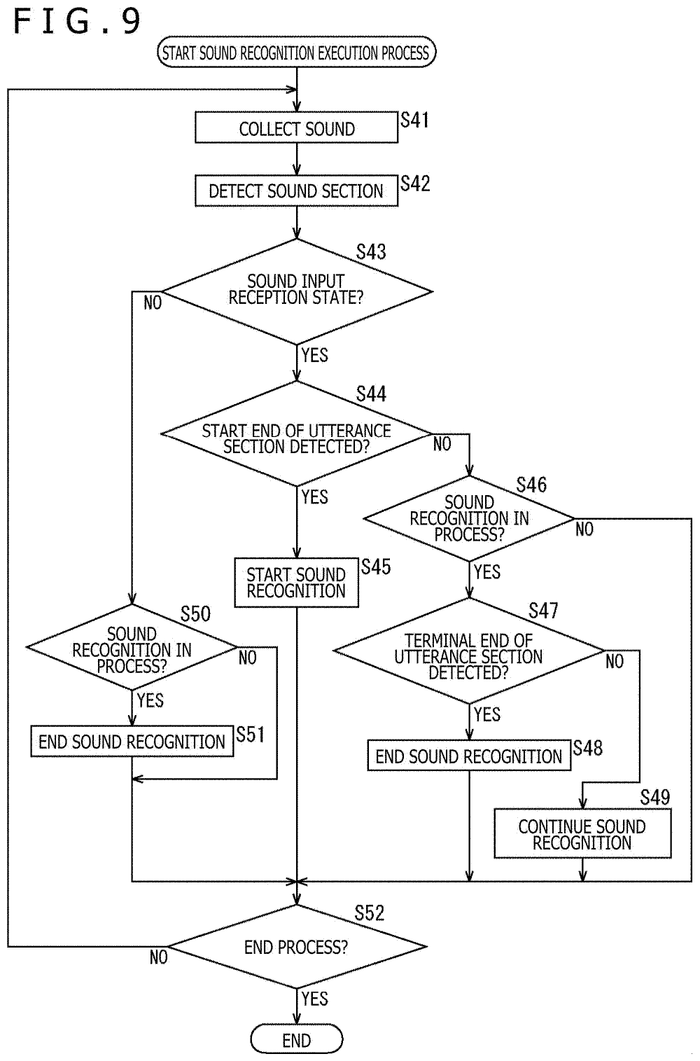

Subsequently, the sound recognition execution process performed by the sound recognition system 11 simultaneously with the input reception control process will be described with reference to a flowchart of FIG. 9.

In step S41, the sound input unit 32 collects ambient sound, and supplies input sound information thus obtained to the sound section detection unit 33.

In step S42, the sound section detection unit 33 detects a sound section on the basis of the input sound information supplied from the sound input unit 32.

Specifically, the sound section detection unit 33 detects an utterance section in the input sound information by sound section detection. In a case where an utterance section is detected, the sound section detection unit 33 supplies a portion corresponding to the utterance section of the input sound information to the input control unit 34 as detected sound information.

In step S43, the input control unit 34 determines whether or not the sound input reception state has been established.

In the case of determination that the sound input reception state has been established in step S43, the process proceeds to step S44.

In step S44, the input control unit 34 determines whether or not a start end of the utterance section has been detected by the sound section detection in step S42.

For example, in a case where supply of the detected sound information from the sound section detection unit 33 has started in the state of establishment of the sound input reception state, the input control unit 34 determines that the start end of the utterance section has been detected.

Moreover, for example, in a case where sound recognition is in process after detection of the start end of the utterance section, or in a case where sound recognition is not performed without detection of the start end of the utterance section yet even in the state of establishment of the sound input reception state, the input control unit 34 determines that the start end of the utterance section has not been detected.

Besides, for example, in a case where the sound input reception state has been established after detection of the start end of the utterance section detected not in the state of establishment of the sound input reception state, it is also determined that the start end of the utterance section has not been detected.

In the case of determination that the start end of the utterance section has been detected in step S44, the input control unit 34 in step S45 starts supply of detected sound information received from the sound section detection unit 33 to the sound recognition unit 22, and therefore the sound recognition unit 22 is allowed to start sound recognition.

The sound recognition unit 22 performs sound recognition for the detected sound information in response to supply of the detected sound information from the input control unit 34. After the start of sound recognition in this manner, the process proceeds to step S52.

When the start end of the utterance section T33 is detected in the state where the sound input reception state has been established as in the example presented in FIG. 3, for example, sound recognition starts in step S45.

On the other hand, in the case of determination that the start end of the utterance section has not been detected in step S44, the input control unit 34 in step S46 determines whether or not sound recognition is in process.

In the case of determination that sound recognition is not in process in step S46, the process proceeds to step S52 without supply of the detected sound information to the sound recognition unit 22.

It is determined that sound recognition is not in process herein in a case where the start end of the utterance section is not detected yet even in the state of establishment of the sound input reception state, in a case where the start end of the utterance section has been detected before establishment of the sound input reception state even currently in the state of establishment of the sound input reception state as in the example presented in FIG. 5, or other situations, for example.

On the other hand, in the case of determination that sound recognition is in process in step S46, the input control unit 34 in step S47 determines whether or not a terminal end of the utterance section has been detected by sound section detection in step S42.

For example, in a case where the continuous supply of the detected sound information from the sound section detection unit 33 until this time ends in the state of establishment of the sound input reception state, the input control unit 34 determines that the terminal end of the utterance section has been detected.

In the case of determination that the terminal end of the utterance section has been detected in step S47, the input control unit 34 in step S48 ends supply of the detected sound information to the sound recognition unit 22, and therefore the sound recognition unit 22 ends sound recognition.

When the terminal end of the utterance section T33 is detected in the state of establishment of the sound input reception state as in the example presented in FIG. 3, for example, sound recognition ends in step S48. In this case, sound recognition is completed for the entire utterance section. Accordingly, the sound recognition unit 22 outputs text information obtained as a result of the sound recognition.

After completion of sound recognition, the process proceeds to step S52.

In addition, in the case of determination that the terminal end of the utterance section has not been detected in step S47, the process proceeds to step S49.

In step S49, the input control unit 34 continues supply of the detected sound information received from the sound section detection unit 33 to the sound recognition unit 22, and therefore the sound recognition unit 22 continues sound recognition. After completion of processing in step S49, the process proceeds to step S52.

In addition, in the case of determination that the sound input reception state has not been established in step S43, the input control unit 34 in step S50 determines whether or not sound recognition is in process.

In the case of determination that sound recognition is in process in step S50, the input control unit 34 in step S51 ends supply of the detected sound information received from the sound section detection unit 33 to the sound recognition unit 22, and therefore the sound recognition unit 22 ends sound recognition.

For example, in a case where the sound input reception state ends in the middle of sound recognition as in the example presented in FIG. 4, processing in step S51 is performed to suspend the process of sound recognition. In other words, the process of sound recognition ends in the middle of the process. After completion of processing in step S51, the process proceeds to step S52.

On the other hand, in the case of determination that sound recognition is not in process in step S50, processing in step S51 is not performed. Thereafter, the process proceeds to step S52.

In a case where processing in step S45, step S48, step S49, or step S51 is performed, or in the case of determination that sound recognition is not in process in step S46 or step S50, processing in step S52 is performed.

In step S52, the input control unit 34 determines whether to end the process. For example, in a case where an instruction of an operation stop of the sound recognition system 11 is issued, an end of the process is determined in step S52.

In a case where an end of the process is not determined in step S52, the process returns to step S41 to repeat the processing described above.

On the other hand, in a case where an end of the process is determined in step S52, operations of the respective units of the sound recognition system 11 are stopped, and the sound recognition execution process ends.

In the manner described above, the sound recognition system 11 controls execution of sound recognition performed by the sound recognition unit 22 according to whether or not the sound input reception state has been established while continuously performing sound collection and sound section detection. Accordingly, reduction of malfunction of the sound recognition function, and improvement of usability of the sound recognition system 11 are realizable by executing sound recognition according to whether or not the sound input reception state has been established.

### Second Embodiment

### <Configuration Example of Sound Recognition System>

Note that the first embodiment described above is the example of the sound recognition system 11 which directly supplies detected sound information output from the sound section detection unit 33 to the input control unit 34. However, the detected sound information output from the sound section detection unit 33 may be temporarily retained in a buffer, and sequentially read by the input control unit 34 from the buffer.

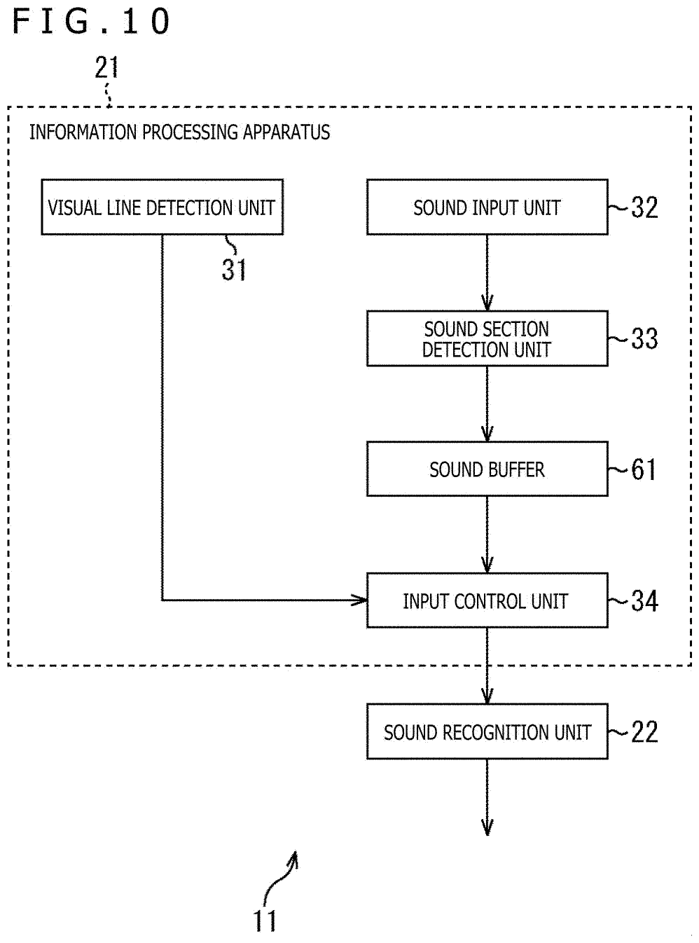

In this case, the sound recognition system 11 is configured as depicted in FIG. 10, for example. Note that parts in FIG. 10 identical to corresponding parts in FIG. 1 are given identical reference signs, and the same description will be omitted where appropriate.

The sound recognition system 11 depicted in FIG. 10 includes the information processing apparatus 21 and the sound recognition unit 22. Moreover, the information processing apparatus 21 includes the visual line detection unit 31, the sound input unit 32, the sound section detection unit 33, a sound buffer 61, and the input control unit 34.

A configuration of the sound recognition system 11 depicted in FIG. 10 is produced by newly adding the sound buffer 61 to the sound recognition system 11 depicted in FIG. 1. Other points of the configuration of the sound recognition system 11 depicted in FIG. 10 are same as the corresponding points of the configuration of the sound recognition system 11 depicted in FIG. 1.

The sound buffer 61 temporarily retains detected sound information supplied from the sound section detection unit 33, and supplies the retained detected sound information to the input control unit 34. The input control unit 34 reads the detected sound information retained in the sound buffer 61, and supplies the detected sound information to the sound recognition unit 22.

For example, consider herein such a case where the user directs the visual line to an input reception visual line position during uttering, i.e., after a start of uttering.

In this case, a start end of an utterance section is detected at timing before a start of the sound input reception state, i.e., at timing not in the sound input reception state in the first embodiment. Accordingly, sound recognition is not performed for this utterance section.

On the other hand, the sound recognition system 11 depicted in FIG. 10 includes the sound buffer 61 which temporarily retains (accumulates) detected sound information.

Accordingly, depending on the size of the sound buffer 61, even in a case where the user directs the visual line to an input reception visual line position after the start of uttering, detected sound information from the start end of the utterance section is allowed to be supplied to the sound recognition unit 22 while tracking back to previous detected sound information retained in the sound buffer 61 at the time of establishment of the sound input reception state.

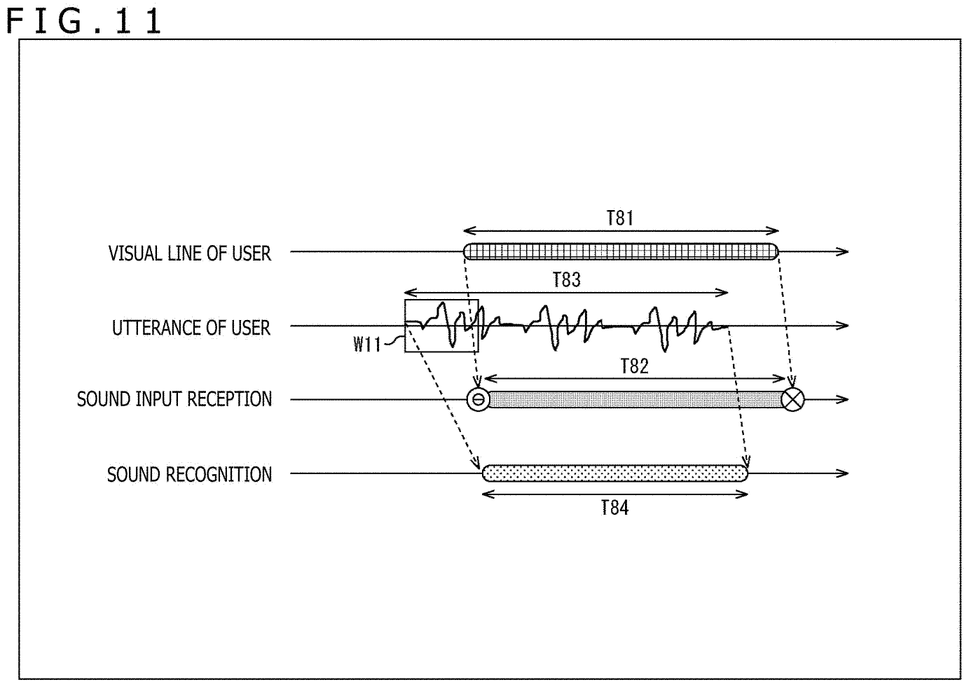

For example, suppose that detected sound information of a volume corresponding to a size of a frame W11 having a rectangular shape is retainable in the sound buffer 61 as depicted in FIG. 11. Note that a horizontal direction indicates a time direction in FIG. 11.

According to an example presented in FIG. 11, a period T81 indicates a period in which the visual line of the user is directed to an input reception visual line position, while a period T82 indicates a period for which the sound input reception state is established.

In addition, according to this example, a start end position of an utterance section T83 is a position (time) before a start end position of the period T82 in terms of time, while a terminal end position of the utterance section T83 is a position (time) before a terminal end position of the period T82 in terms of time.

In other words, the user directs the visual line to an input reception visual line position after a start of an utterance, and shifts the visual line from the input reception visual line position after an end of the utterance.

However, detected sound information corresponding to a portion surrounded by the frame W11 in the utterance section T83 is retained in the sound buffer 61.

Particularly herein, detected sound information associated with a section having a predetermined length and including the start end portion of the utterance section T83 is retained in the sound buffer 61.

Accordingly, the input control unit 34 can read the detected sound information from the sound buffer 61, supply the detected sound information to the sound recognition unit 22, and cause the sound recognition unit 22 to start sound recognition at the timing of the start end position of the period T82, i.e., at the timing when the user directs the visual line to the input reception visual line position. In this manner, sound recognition for the entire utterance section T83 is performed in the period T84, for example.

Specifically, in this case, the input control unit 34 detects the start end of the utterance section T83 while tracking back to previous detected sound information retained in the sound buffer 61. Thereafter, when the start end of the utterance section T83 is detected, the input control unit 34 sequentially supplies the detected sound information retained in the sound buffer 61 to the sound recognition unit 22 in the order from the detected sound information corresponding to the start end portion.

It is sufficient if the range of tracking back to detect the start end of the utterance section with reference to the sound buffer 61 is determined according to a setting value determined beforehand, the volume (size) of the sound buffer 61, or the like.

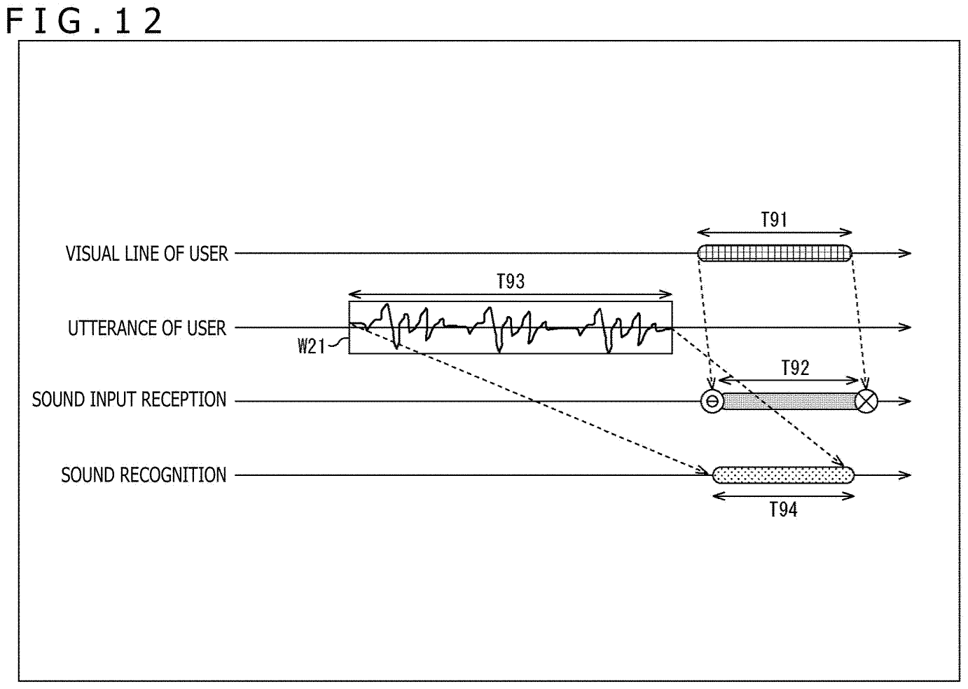

Moreover, the sound buffer 61 sized to store all detected sound information corresponding to one utterance of the user may be prepared. In this manner, the detected sound information can be supplied to the sound recognition unit 22 from the start end of the utterance section even in a case where the user directs the visual line to the input reception visual line position after the end of the utterance as presented in FIG. 12, for example. Note that a horizontal direction indicates a time direction in FIG. 12.

According to an example presented in FIG. 12, a period T91 indicates a period in which the visual line of the user is directed to the input reception visual line position, while a period T92 indicates a period for which the sound input reception state is established.

According to this example, a terminal end position of an utterance section T93 is, in terms of time, a position (time) before a start end position of the period T92 for which the sound input reception state is established.

However, according to the sound recognition system 11, detected sound information corresponding to a portion surrounded by a frame W21 having a rectangular shape is retained in the sound buffer 61. Particularly herein, the detected sound information associated with the entire utterance section T93 is retained in the sound buffer 61.

Accordingly, when the user directs the visual line to the input reception visual line position after the end of the utterance, detected sound information corresponding to the portion of the utterance section T93 retained in the sound buffer 61 is supplied to the sound recognition unit 22 to start sound recognition similarly to the case presented in FIG. 11. In this manner, sound recognition for the entire utterance section T93 is performed in a period T94, for example.

However, the sound input reception state ends when the user shifts the visual line from the input reception visual line position. Accordingly, the user is required to continuously direct the visual line to the input reception visual line position while sound recognition for the entire utterance section T93 is performed.

The sound recognition system 11 including the sound buffer 61 as described above also performs the input reception control process described with reference to FIG. 8, and the sound recognition execution process described with reference to FIG. 9.

However, in a case where an utterance section is detected by sound section detection in step S42 in the sound recognition execution process, detected sound information associated with this utterance section is supplied from the sound section detection unit 33 to the sound buffer 61, and retained in the sound buffer 61. The sound buffer 61 at this time recognizes which portion is the start end portion of the utterance section in the retained detected sound information.

In addition, in step S44 and step S47, the input control unit 34 detects the start end and the terminal end of the utterance section on the basis of the detected sound information retained in the sound buffer 61, and appropriately supplies the detected sound information retained in the sound buffer 61 to the sound recognition unit 22.

According to the sound recognition system 11 depicted in FIG. 10, sound recognition is achievable as intended by the user even when the timing of an utterance of the user and the timing for directing the visual line of the user to an input reception visual line position deviate from each other.

### Third Embodiment

### <Configuration Example of Sound Recognition System>

Note that either a single input reception visual line position, or a plurality of input reception visual line positions may be provided as the input reception visual line position described above. For example, when a plurality of the input reception visual line positions is prepared, the user is allowed to continue input of sound while shifting the visual line to a plurality of apparatuses in a case where these apparatuses are operated by using the single system, i.e., the one sound recognition system 11.

Moreover, the sound recognition system 11 may dynamically add an input reception visual line position, or delete an input reception visual line position by recognizing contents of an utterance, i.e., a context of the user.

Specifically, in a case where the user gives an utterance “turn on TV,” for example, the input control unit 34 adds a position (region) where TV is located as an input reception visual line position on the basis of a recognition result obtained by the sound recognition unit 22, i.e., a context. By contrast, in a case where the user gives an utterance “turn off TV,” for example, the input reception visual line positions are updated such that the position of TV is not included in the input reception visual line positions. In other words, the position of TV registered as the input reception visual line is deleted.

This dynamical deletion of the input reception visual line position can prevent an unintentional start of supply of detected sound information to the sound recognition unit 22 caused as a result of an excessive increase in the number of input reception visual line positions.

Note that the input reception visual line position may be set, i.e., added or deleted manually, or by the sound recognition system 11 using an image recognition technology or the like.

Moreover, in a case where a plurality of the input reception visual line positions is provided, particularly in a case where a position designated as an input reception visual line position is dynamically added or deleted, a current position designated as an input reception visual line position may be difficult to recognize by the user. Accordingly, the position designated as the input reception visual line position may be expressly presented by indication on a display, output of sound from a speaker, or the like.

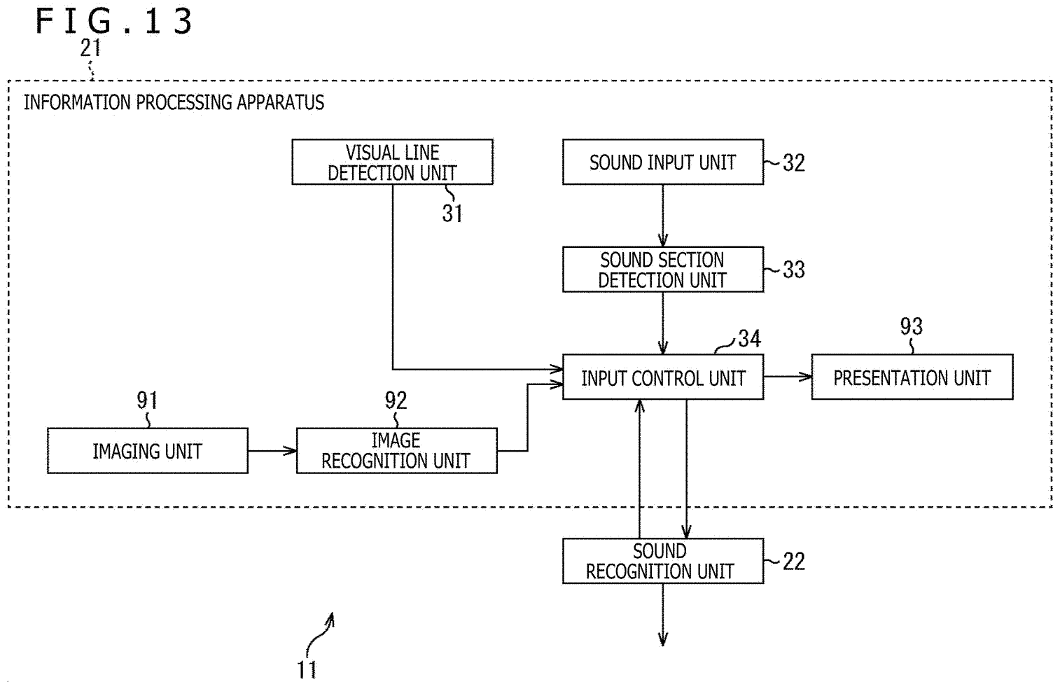

In a case where an input reception visual line position is dynamically added or deleted, the sound recognition system 11 is configured as depicted in FIG. 13, for example. Note that parts in FIG. 13 identical to corresponding parts in FIG. 1 are given identical reference signs, and the same description will be omitted where appropriate.

The sound recognition system 11 depicted in FIG. 13 includes the information processing apparatus 21 and the sound recognition unit 22. Moreover, the information processing apparatus 21 includes the visual line detection unit 31, the sound input unit 32, the sound section detection unit 33, the input control unit 34, an imaging unit 91, an image recognition unit 92, and a presentation unit 93.

A configuration of the sound recognition system 11 depicted in FIG. 13 is produced by newly adding the imaging unit 91 through the presentation unit 93 to the sound recognition system 11 depicted in FIG. 1. Other points of the configuration of the sound recognition system 11 depicted in FIG. 13 are same as the corresponding points of the configuration of the sound recognition system 11 depicted in FIG. 1.

For example, the imaging unit 91 includes a camera or the like, and images surroundings of the information processing apparatus 21 as an object, and supplies an image thus obtained to the image recognition unit 92.

The image recognition unit 92 performs image recognition for the image supplied from the imaging unit 91, and supplies information indicating a position (direction) of a predetermined device or the like located around the information processing apparatus 21 to the input control unit 34 as an image recognition result. For example, the image recognition unit 92 detects a target which may become an input reception visual line position determined beforehand, such as a device, by utilizing image recognition.

The input control unit 34 retains registration information indicating one or a plurality of places (positions) designated as input reception visual line positions, and manages registered information on the basis of sound recognition results supplied from the sound recognition unit 22, or image recognition results supplied from the image recognition unit 92. In other words, the input control unit 34 dynamically adds or deletes the places (positions) designated as the input reception visual line positions. Note that the management of the registered information may be only either addition or deletion of the input reception visual line positions.

For example, the presentation unit 93 includes a display unit such as a display, a speaker, a light emitting unit, and the like, and configured to give presentation associated with the input reception visual line positions to the user under control by the input control unit 34.

Note that the imaging unit 91, the image recognition unit 92, and the presentation unit 93 may be provided on a device different from the information processing apparatus 21. Moreover, the presentation unit 93 may be eliminated, and the sound buffer 61 depicted in FIG. 10 may be further provided on the sound recognition system 11 depicted in FIG. 13.

### <Description of Update Process>

The sound recognition system 11 depicted in FIG. 13 performs the input reception control process described with reference to FIG. 8, and the sound recognition execution process described with reference to FIG. 9, and further performs an update process for updating registered information simultaneously with the input reception control process and the sound recognition execution process.

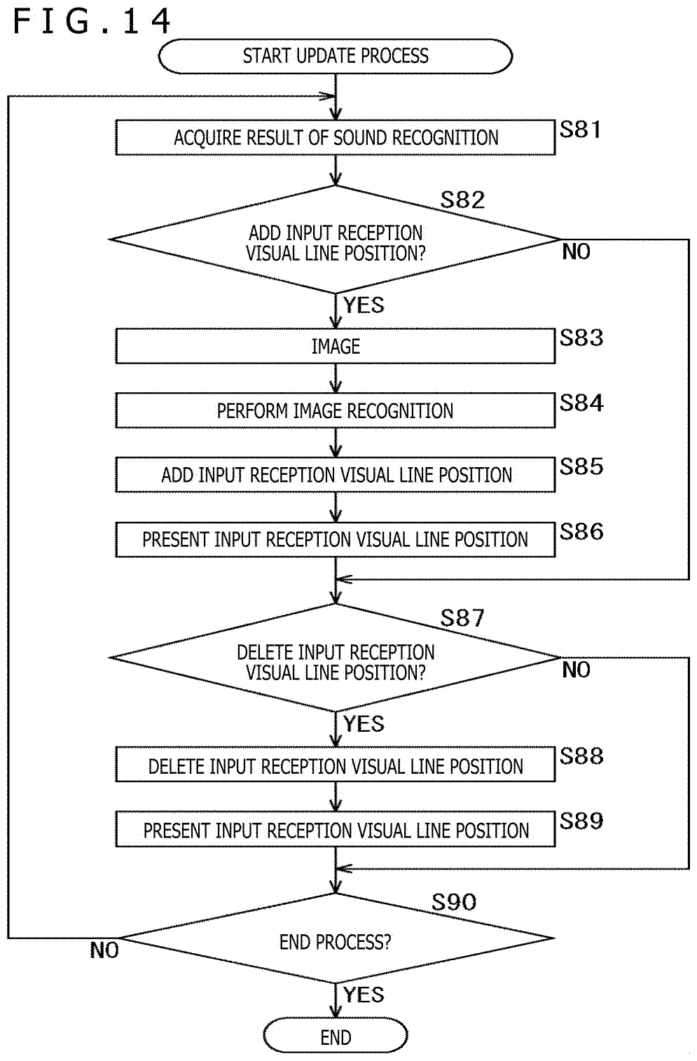

The update process performed by the sound recognition system 11 will be hereinafter described with reference to a flowchart in FIG. 14.

In step S81, the input control unit 34 acquires a sound recognition result from the sound recognition unit 22. For example, text information indicating detected sound, i.e., text information indicating utterance contents of the user is acquired herein as the sound recognition result.

In step S82, the input control unit 34 determines whether to add an input reception visual line position on the basis of the sound recognition result acquired in step S81, and the retained registered information.

For example, in a case where text information acquired as the sound recognition result is “turn on TV” without registration of the position of TV as an input reception visual line position in the registered information, addition of the input reception visual line position is determined. In this case, the position of TV is added as a new input reception visual line position.

In a case where addition of the input reception visual line position is not determined in step S82. In this case, the process proceeds to step S87 while skipping processing from step S83 to step S86.

On the other hand, in a case where addition of the input reception visual line position is determined in step S82, the imaging unit 91 in step S83 images surroundings of the information processing apparatus 21 as an object, and supplies an image thus obtained to the image recognition unit 92.

In step S84, the image recognition unit 92 performs image recognition for the image supplied from the imaging unit 91, and supplies an image recognition result thus obtained to the input control unit 34.

In step S85, the input control unit 34 adds the new input reception visual line position.

Specifically, the input control unit 34 updates the retained registered information such that the position determined to be added in step S82 is registered (added) as an input reception visual line position on the basis of the image recognition result supplied from the image recognition unit 92.

For example, in a case where the position of TV is added as a new input reception visual line position, information indicating the position of TV presented in the image recognition result, i.e., a direction where TV is located, is added to the registered information as information indicating the new input reception visual line position.

In response to addition of the new input reception visual line position, the input control unit 34 appropriately supplies text information, sound information, direction information, and the like indicating the added input reception visual line position to the presentation unit 93, and gives an instruction of presentation of the newly added input reception visual line position.

In step S86, the presentation unit 93 presents the input reception visual line position in accordance with the instruction from the input control unit 34.

For example, in a case where the presentation unit 93 has a display, the display displays text information indicating the input reception visual line position supplied from the input control unit 34 and newly added, text information indicating the input reception visual line positions currently registered in the registered information, and the like.

Specifically, for example, text information such as “TV is added as input reception visual line position” can be displayed on the display. In addition, a direction of the input reception visual line position newly added may be displayed on the display, or a light emitting unit located in the direction of the input reception visual line position newly added in a plurality of light emitting units constituting the presentation unit 93 may be lit, for example.

Moreover, in a case where the presentation unit 93 has a speaker, the speaker outputs a sound message on the basis of sound information indicating the input reception visual line position supplied from the input control unit 34 and newly added, sound information indicating the input reception visual line positions currently registered in the registered information, and the like.

After completion of presentation of the input reception visual line position, the process proceeds to step S87.

In a case where processing in step S86 is completed, or addition of the input reception visual line position is not determined in step S82, processing in step S87 is performed.

In step S87, the input control unit 34 determines whether to delete an input reception visual line position on the basis of the sound recognition result acquired in step S81 and the retained registered information.

For example, in a case where text information acquired as the sound recognition result is “turn off TV” with registration of the position of TV as an input reception visual line position in the registered information, deletion of the input reception visual line is determined. In this case, the position of TV registered as an input reception visual line position is deleted from the registered information.

In a case where deletion of the input reception visual line position is not determined in step S87, the process proceeds to step S90 while skipping processing in step S88 and step S89.

On the other hand, in a case where deletion of the input reception visual line position is determined in step S87, the input control unit 34 deletes the input reception visual line position in step S88.

Specifically, the input control unit 34 updates the retained registered information such that information indicating the input reception visual line position determined to be deleted in step S87 is deleted from the registered information.

For example, in a case where the position of TV registered as an input reception visual line position is deleted, the input control unit 34 deletes, from the registered information, information indicating the position of TV registered in the registered information, i.e., included in the registered information.

In response to deletion of the input reception visual line position, the input control unit 34 appropriately supplies text information, sound information, direction information, and the like indicating the deleted input reception visual line position to the presentation unit 93, and gives an instruction of presentation of the deleted input reception visual line position.

In step S89, the presentation unit 93 presents the deleted input reception visual line position in accordance with the instruction from the input control unit 34.

For example, in step S89, text information indicating the deleted input reception visual line position is displayed on the display, or a sound message indicating deletion of a specific position (place) from the input reception visual line positions is output from the speaker, similarly to the case in step S86.

Note that text information or a sound message indicating the input reception visual line positions registered in the registered information after update may be presented in this case.

In a case where processing in step S89 is completed, or deletion of the input reception visual line position is not determined in step S87, processing in step S90 is performed.

In step S90, the input control unit 34 determines whether to end the process. For example, in a case where an instruction of an operation stop of the sound recognition system 11 is issued, an end of the process is determined in step S90.

In a case where an end of the process is not determined in step S90, the process returns to step S81 to repeat the processing described above.

On the other hand, in a case where an end of the process is determined in step S90, operations of the respective units of the sound recognition system 11 are stopped, and the update process ends.

In the manner described above, the sound recognition system 11 adds or deletes an input reception visual line position on the basis of a sound recognition result, i.e., a context of an utterance of the user.

This manner of dynamic addition and deletion of the input reception visual line position allows addition of a position desired to be registered for convenience as an input reception visual line position, or deletion of an unnecessary input reception visual line position, thereby improving usability. Moreover, presentation of the added or deleted input reception visual line position allows the user to easily recognize addition or deletion of the input reception visual line position.

### Fourth Embodiment

### <End of Sound Input Reception State>

Meanwhile, according to the sound recognition system 11 described above, a transition to the sound input reception state is achieved when the user shifts the visual line to an input reception visual line position. The sound input reception state is ended when the user shifts the visual line from the input reception visual line position. In other words, according to the above description, the sound input reception state ends in a case where a condition that the visual line of the user is not directed to the input reception visual line position is met.

However, in the case of visual line detection, a shift of the visual line of the user from the input reception visual line position may be determined against an intension of the user.

This determination against the intension of the user is caused by erroneous detection of a visual line, a presence of a blocking object passing between the user and the visual line detection unit 31, or a temporary shift of the visual line of the user from the input reception visual line position, for example.

In these cases, a condition for determining a shift of the visual line of the user from the input reception visual line position may be specified so as not to suspend sound recognition against the intension of the user. In other words, the input control unit 34 may end the sound input reception state only in a case where a predetermined condition based on visual line information is met.

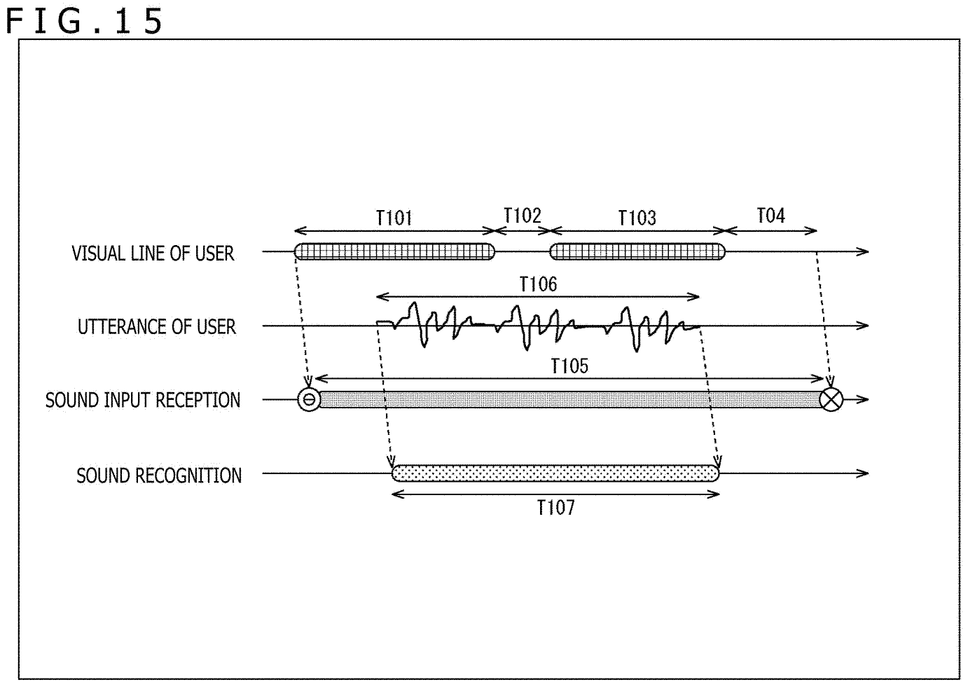

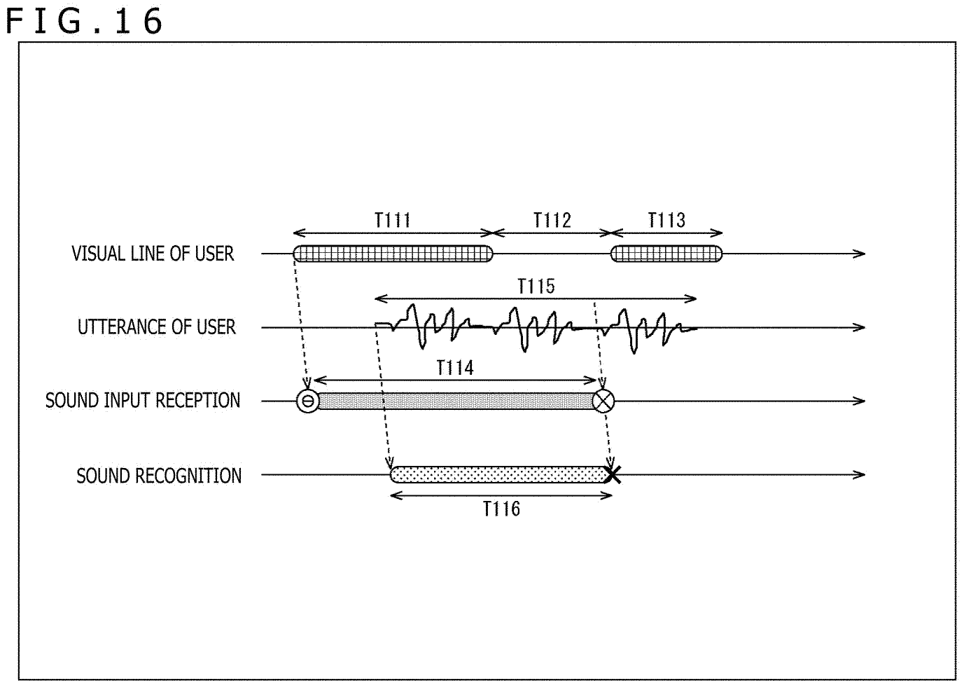

Specifically, the sound input reception state may be ended in a case where duration of a shift of the visual line of the user from an input reception visual line position exceeds a fixed time as presented in FIGS. 15 and 16, for example. Note that a horizontal direction indicates a time direction in FIGS. 15 and 16.

According to an example presented in FIG. 15, each of periods T101 and T103 indicates a period in which the visual line of the user is directed to the input reception visual line position, while each of periods T102 and T104 indicates a period of a shift of the visual line of the user from the input reception visual line position.

In addition, it is assumed that a time (duration) for determining an end of the sound input reception state on the basis of a continuous shift of the visual line of the user from the input reception visual line position is expressed as a threshold th1.

According to this example, the input control unit 34 determines that the visual line of the user is directed to the input reception visual line position in the period T101. Accordingly, the sound input reception state is established at timing of a start end of the period T101.

Moreover, the input control unit 34 determines that the visual line of the user is shifted from the input reception visual line position in the period T102 after the period T101, and determines that the visual line is again directed to the input reception visual line position in the period T103 after the period T102.

After the sound input reception state is established, a shift of the visual line of the user from the input reception visual line position is determined in the period T102. However, a length of the period T102 is equal to or shorter than the threshold th1, and therefore the input control unit 34 continuously establishes the sound input reception state.

Specifically, after the sound input reception state is established, the user temporarily shifts the visual line from the input reception visual line position. However, because duration of the shift of the visual line is shorter than the threshold th1, the sound input reception state is maintained.

Moreover, after termination of the period T103, a shift of the visual line of the user from the input reception visual line position is determined. Thereafter, the input control unit 34 ends the sound input reception state at the time when duration of continuous determination of a shift of the visual line of the user from the input reception visual line position exceeds the threshold th1.

Specifically, the period T104 after the period T103 is a period in which the visual line of the user is shifted from the input reception visual line position, and is longer than the threshold th1. In this case, the sound input reception state is ended. Accordingly, a period T105 continuing immediately after a start end of the period T101 until immediately after a terminal end of the period T104 is a period for which the sound input reception state is established.

According to this example, an utterance section T106 is detected from input sound within the period T105 for which the sound input reception state is established. In a period T107, sound recognition for the entire utterance section T106 is performed, and a recognition result thus obtained is output.

In addition, according to an example presented in FIG. 16, each of periods T111 and T113 indicates a period in which the visual line of the user is directed to the input reception visual line position, while a period T112 indicates a period in which the visual line of the user is shifted from the input reception visual line position.

According to this example, the input control unit 34 determines that the visual line of the user is directed to the input reception visual line position in the period T111. Accordingly, the sound input reception state is established at timing of a start end of the period T111.

Moreover, the input control unit 34 determines that the visual line of the user is shifted from the input reception visual line position in the period T112 after the period T111, and determines that the visual line is directed to the input reception visual line position in the period T113 after the period T112.

The period T112 subsequent to the period T111 is a period longer than the threshold th1. Accordingly, the input control unit 34 ends the sound input reception state at the time when duration of continuous determination of a shift of the visual line of the user from the input reception visual line position exceeds the threshold th1 after a start of the period T112.

Accordingly, a period T114 continuing immediately after a start end of the period T111 until an intermediate time of the period T112 herein is a period for which the sound input reception state is established.

Moreover, according to this example, a start end of an utterance section T115 is detected from input sound at timing within the period T111 for which the sound input reception state is established. However, a terminal end of the utterance section T115 is timing (time) within the period T113 for which the sound input reception state is not established.

A portion after the start end of the utterance section T115 in the input sound information is designated as detected sound information herein, and supply of the detected sound information to the sound recognition unit 22 is started. However, the sound input reception state ends before detection of the terminal end of the utterance section T115, and supply of the detected sound information to the sound recognition unit 22 is suspended. Specifically, sound recognition is performed in a period T116 corresponding to a part of the period of the utterance section T115. The process of sound recognition is suspended along with the end of the sound input reception state.

As described above, when the visual line of the user is shifted from the input reception visual line position in a state of establishment of the sound input reception state, the input control unit 34 measures duration of the shift of the visual line of the user from the input reception visual line position.

Thereafter, the input control unit 34 ends the sound input reception state regarding that the user has moved (shifted) the visual line from the input reception visual line position at the time when the measured duration exceeds the threshold th1. Specifically, the sound input reception state is ended herein regarding that the above predetermined condition has been met in a case where duration of a state of the visual line of the user not directed to the input reception visual line position exceeds the threshold th1 after the start of the sound input reception state.

In this manner, appropriate sound recognition execution control is achievable by maintaining the sound input reception state even in the case of an unintentional temporary shift of the visual line of the user, for example.

Note that the input control unit 34 may measure a total time, i.e., a cumulative time of a shift of the visual line of the user from the input reception visual line position in the case of establishment of the sound input reception state, and end the sound input reception state at the time when the cumulative time exceeds a predetermined threshold th2.

In other words, the sound input reception state may be ended regarding that the above predetermined condition has been met in a case where the cumulative time of the state of the visual line of the user not directed to the input reception visual line position exceeds the threshold th2 after the start of the sound input reception state. Even in this case, control similar to the control presented in FIGS. 15 and 16 is performed.

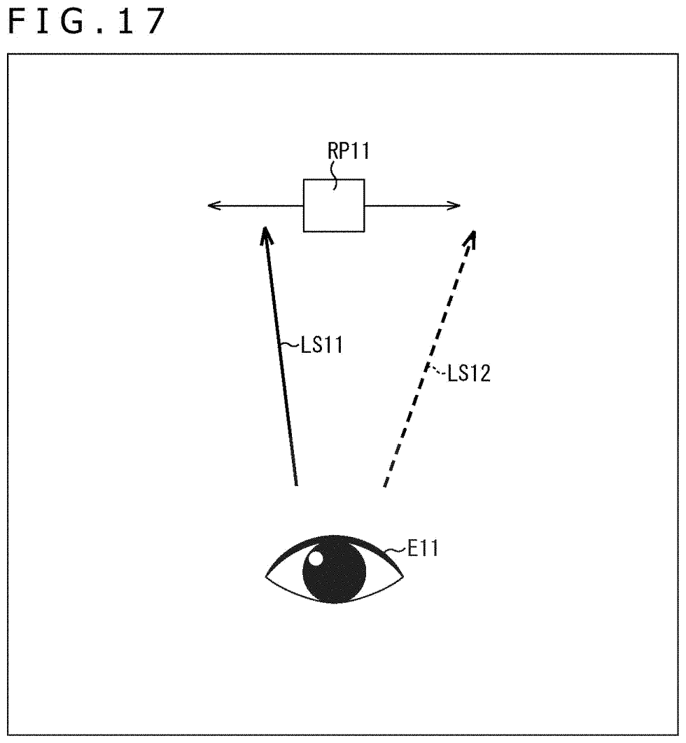

Moreover, as presented in FIG. 17, only a slight shift of the visual line of the user from an input reception visual line position may be made insufficient for ending the sound input reception state, for example.

According to an example presented in FIG. 17, each of arrows LS11 and LS12 indicates a visual line direction of the user.

The sound input reception state is established herein when an eye Ell, i.e., the visual line of the user is directed to an input reception visual line position RP11.

Thereafter, suppose that the user slightly shifts the visual line from the input reception visual line position RP11 in a state of establishment of the sound input reception state as indicated by the arrow LS11, for example. Specifically, for example, it is assumed that a difference between a direction of the input reception visual line position RP11 and a visual line direction indicated by the arrow LS11 is equal to or smaller than a threshold determined beforehand. This difference indicates deviation between the direction of the visual line of the user and the direction of the input reception visual line position.

In this case, the input control unit 34 does not end the sound input reception state, and maintains the sound input reception state until the difference between the direction of the input reception visual line position RP11 and the visual line direction of the user exceeds the threshold.

Thereafter, the user shifts the visual line to a position greatly deviating from the input reception visual line position RP11 as indicated by the arrow LS12, for example. Accordingly, the input control unit 34 ends the sound input reception state at the time when a difference between the direction of the input reception visual line position RP11 and a visual line direction indicated by the arrow LS12 exceeds the threshold. In other words, the sound input reception state is ended regarding that the above predetermined condition has been met in a case where a degree of deviation between the direction of the visual line of the user and the direction of the input reception visual line position exceeds a predetermined threshold.

In this manner, according to the example presented in FIG. 17, the input control unit 34 determines whether to end the sound input reception state according to the degree of deviation of the visual line of the user from the input reception visual line position. In this manner, the sound input reception state is maintained even in the case of low accuracy of visual line detection, or slight deviation of the visual line of the user from the input reception visual line position. Accordingly, appropriate sound recognition execution control is achievable.

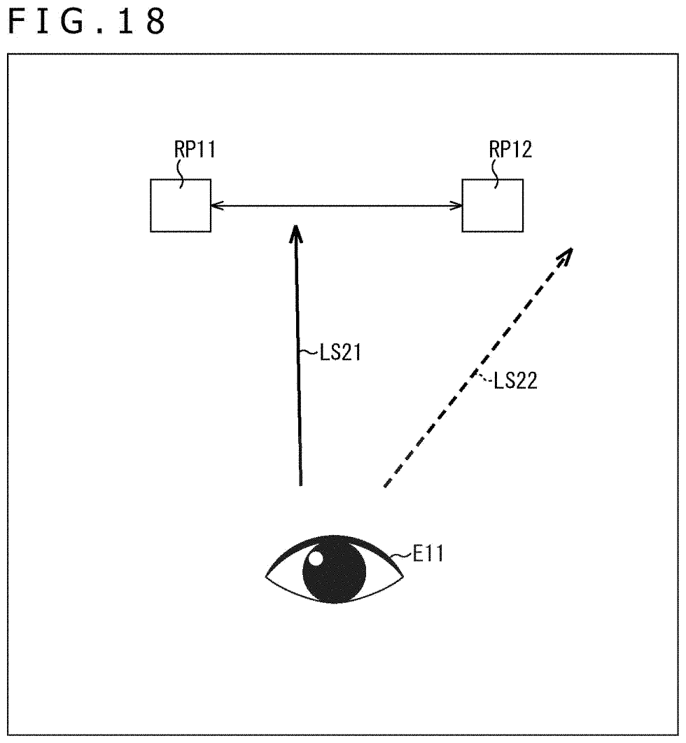

In addition, in a case where a plurality of input reception visual line positions is present, the sound input reception state may be maintained when the visual line of the user is located between two of the input reception visual line positions as depicted in FIG. 18, for example. Note that parts in FIG. 18 identical to corresponding parts in FIG. 17 are given identical reference signs, and the same description will be omitted where appropriate.

For example, suppose that the user directs the visual line to an input reception visual line position RP12 after establishment of the sound input reception state based on the visual line of the user directed to the input reception visual line position RP11 in the example depicted in FIG. 18.

In this case, the input control unit 34 maintains the sound input reception state while the visual line of the user is located between the input reception visual line position RP11 and the input reception visual line position RP12 as indicated by an arrow LS21.

On the other hand, the input control unit 34 ends the sound input reception state in a case where the visual line of the user is not located between the input reception visual line position RP11 and the input reception visual line position RP12, and deviates from the input reception visual line position RP11 and the input reception visual line position RP12 as indicated by an arrow LS22, for example.

In other words, the sound input reception state is ended regarding that the above predetermined condition has been met in a case where the direction of the visual line of the user is neither any one of directions of a plurality of the input reception visual line positions, nor a direction located between two of the input reception visual line positions.

In this manner, it is possible to prevent an end of the sound input reception state against the intention of the user in a case where the user shifts the visual line from a predetermined input reception visual line position to another input reception visual line position. Accordingly, more appropriate sound recognition execution control is achievable.

Furthermore, as described above, the method of comparing duration or a cumulative time of a shift of the visual line of the user from an input reception visual line position with a threshold, the method of comparing a difference between a visual line direction of the user and a direction of an input reception visual line position with a threshold, and the method of maintaining the sound input reception state in a case where the visual line of the user is located between two input reception visual line positions may be combined in an appropriate manner.

In addition, in the case of adoption of these methods or the like, appropriate display is preferably presented to the user.

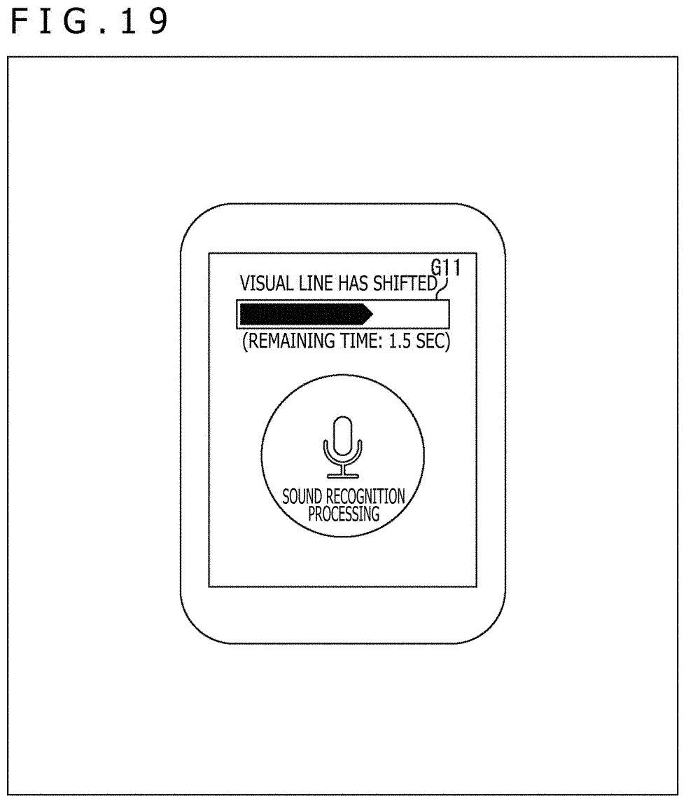

Specifically, for example, display depicted in FIG. 19 is given in the case of comparison between a threshold and duration or a cumulative time of a shift of the visual line of the user from an input reception visual line position.

According to the example presented in FIG. 19, a character message “visual line has shifted” indicating a shift of the visual line from an input reception visual line position is displayed on a display screen displayed to the user. This display allows the user to recognize the shift of the visual line from the input reception visual line position.

Moreover, a gauge G11 is displayed on the display screen. In addition, in a case where the user maintains the shift of the visual line from the input reception visual line position, a character message “remaining time: 1.5 sec” indicating a remaining time until an end of the sound input reception state is also displayed on the display screen.

For example, the gauge G11 indicates actual duration or cumulative time of the shift of the visual line of the user from the input reception visual line position with respect to the duration or the cumulative time until the end of the sound input reception state, i.e., the threshold th1 or the threshold th2 described above.

The user is capable of recognizing the time left or the like until the end of the sound input reception state by looking at the gauge G11 or the character message “remaining time: 1.5 sec” described above.

Furthermore, a character message “sound recognition processing” indicating sound recognition is in process, and an image of a microphone indicating that sound recognition is in process are displayed on the display screen.

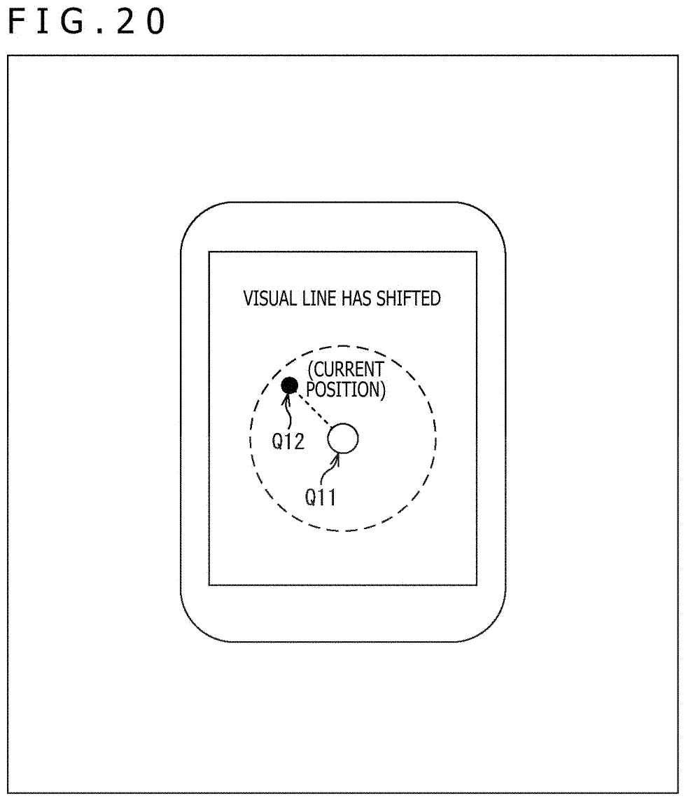

Moreover, for example, a display screen depicted in FIG. 20 may be displayed as a display indicating a shift of the visual line of the user from the input reception visual line position.

According to this example, a circle indicated by an arrow Q11 in the display screen represents a device equipped with the visual line detection unit 31, i.e., the information processing apparatus 21, while a circle indicated by an arrow Q12 located near a position of characters “current position” represents a current position of the visual line of the user. Furthermore, a character message “visual line has shifted” indicating a shift of the visual line of the user from an input reception visual line position is also displayed on the display screen.

The user is capable of easily recognizing a shift of the visual line of the user from an input reception visual line position, and a direction and a degree of the shift of the visual line on the basis of these presentations on the display screen.

### <Configuration Example of Sound Recognition System>

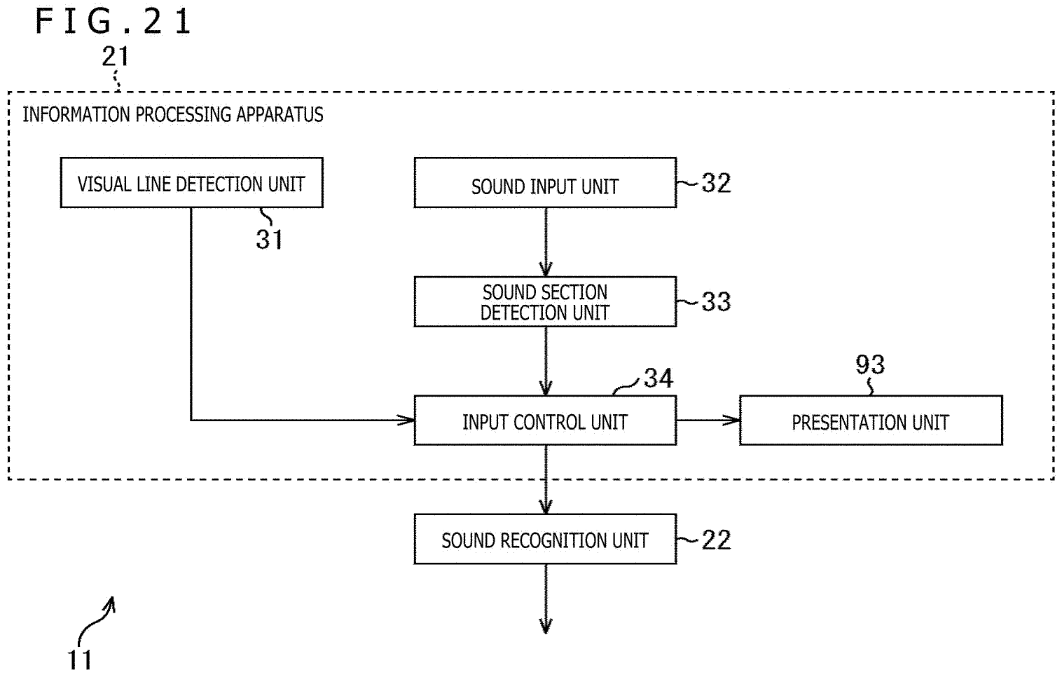

For display by the sound recognition system 11 as depicted in FIGS. 19 and 20, the sound recognition system 11 is configured as depicted in FIG. 21, for example. Note that parts in FIG. 21 identical to corresponding parts in FIG. 13 are given identical reference signs, and the same description will be omitted where appropriate.

The sound recognition system 11 depicted in FIG. 21 includes the information processing apparatus 21 and the sound recognition unit 22. Moreover, the information processing apparatus 21 includes the visual line detection unit 31, the sound input unit 32, the sound section detection unit 33, the input control unit 34, and the presentation unit 93.

A configuration of the sound recognition system 11 depicted in FIG. 21 is produced by eliminating the imaging unit 91 and the image recognition unit 92 from the sound recognition system 11 depicted in FIG. 13.

According to the sound recognition system 11 depicted in FIG. 21, the presentation unit 93 includes a display and the like, and displays the display screen depicted in FIG. 19 or 20 or the like in accordance with an instruction from the input control unit 34. Specifically, the presentation unit 93 gives to the user a presentation indicating a shift (deviation) of the direction of the visual line of the user from an input reception visual line position.

### <Description of Input Reception Control Process>

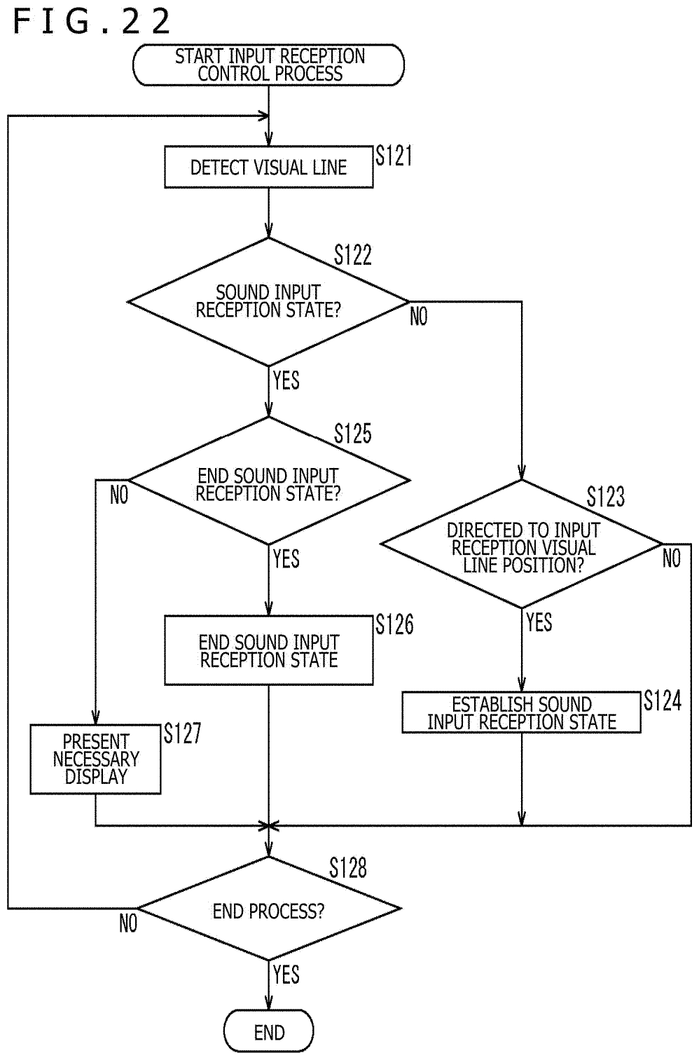

The sound recognition system 11 depicted in FIG. 21 performs a process presented in FIG. 22 as an input reception control process. The input reception control process performed by the sound recognition system 11 depicted in FIG. 21 will be hereinafter described with reference to a flowchart in FIG. 22.

Note that processing from steps S121 to S124 is similar to the processing from steps S11 to S14 in FIG. 8. Accordingly, the same description of this processing will be omitted. However, after completion of processing in step S124, or when the visual line not directed to the input reception visual line position is determined in step S123, the process subsequently proceeds to step S128.

Moreover, in the case of determination that the sound input reception state has been established in step S122, the input control unit 34 in step S125 determines whether to end the sound input reception state on the basis of visual line information supplied from the visual line detection unit 31.

For example, when the sound input reception state is established, the input control unit 34 measures duration or a cumulative time of the shift of the visual line of the user from the input reception visual line position after establishment of the sound input reception state on the basis of visual line information.

Thereafter, the input control unit 34 determines an end of the sound input reception state in a case where the duration time obtained by measurement exceeds the threshold th1 described above, a case where the cumulative time obtained by measurement exceeds the threshold th2 described above, or other cases, for example.

In addition, the input control unit 34 may determine an end of the sound input reception state in a case where a difference between a direction of the visual line of the user indicated by the visual line information and a direction of the input reception visual line position exceeds a threshold determined beforehand, for example. In this case, the end of the sound input reception state is not determined while the difference is equal to or smaller than the threshold.

Furthermore, in a case where a plurality of input reception visual line positions is present, for example, the input control unit 34 may determine not to end the sound input reception state in a state where the direction of the visual line of the user indicated by the visual line information is a direction of any one of the input reception visual line positions, or in a state where the direction of the visual line of the user indicated by the visual line information is a direction between two of the input reception visual line positions.

In this case, the input control unit 34 determines an end of the sound input reception state neither in the case where the direction of the visual line of the user indicated by the visual line information is a direction of any one of the input reception visual line positions, nor in the case where the direction of the visual line of the user indicated by the visual line information is a direction between two of the input reception visual line positions.

In a case where an end of the sound input reception state is determined in step S125, the input control unit 34 ends the sound input reception state in step S126. After completion of processing in step S126, the process proceeds to step S128.

On the other hand, in a case where an end of the sound input reception state is not determined in step S125, the input control unit 34 issues to the presentation unit 93 an instruction of display indicating a shift of the visual line as necessary. Thereafter, the process proceeds to step S127.

In step S127, the presentation unit 93 presents necessary display in accordance with the instruction from the input control unit 34.

Specifically, in a case where the visual line of the user is shifted from the input reception visual line position even in the state of establishment of the sound input reception state, for example, the presentation unit 93 displays a display screen indicating the shift of the visual line. Accordingly, the display depicted in FIG. 19 or 20 is presented, for example. After completion of processing in step S127, the process proceeds to step S128.

Processing in step S128 is performed after determination that the visual line is not directed to the input reception visual line position in step S123, completion of processing in step S124, completion of processing in step S126, or completion of processing in step S127.

In step S128, the input control unit 34 determines whether to end the process. For example, in a case where an instruction of an operation stop of the sound recognition system 11 is issued, an end of the process is determined in step S128.

In a case where an end of the process is not determined in step S128, the process returns to step S121 to repeat the processing described above.

On the other hand, in a case where an end of the process is determined in step S128, operations of respective units of the sound recognition system 11 are stopped, and the input reception control process ends.

In the manner described above, the sound recognition system 11 establishes the sound input reception state when the visual line of the user is directed to an input reception visual line position. The sound recognition system 11 ends the sound input reception state according to duration and a cumulative time of a shift of the visual line of the user from the input reception visual line position.

In this manner, an end of the sound input reception state against an intention of the user is avoidable, and therefore more appropriate sound recognition execution control is achievable. Moreover, a shift of the visual line from the input reception visual line position and the like can be presented to the user by displaying an indication of the shift of the visual line. Accordingly, usability improves.

The sound recognition system 11 depicted in FIG. 21 also performs the sound recognition execution process described with reference to FIG. 9 simultaneously with the input reception control process described with reference to FIG. 22.

Furthermore, when dynamic addition or deletion of an input reception visual line position is allowed in the sound recognition system 11 configured as depicted in FIG. 13, the update process described with reference to FIG. 14 is also performed simultaneously with the input reception control process and the sound recognition execution process.

### Fifth Embodiment

### <Configuration Example of Sound Recognition System>

Besides, described above is the state where input of detected sound information is received as a specific example of the sound input reception state, i.e., the state where sound input is received to perform sound recognition.

In this case, in a state other than the sound input reception state, the detected sound information is not supplied to the sound recognition unit 22. However, sound collection by the sound input unit 32 and sound section detection by the sound section detection unit 33 are constantly performed regardless of whether or not the sound input reception state has been established.

Accordingly, for example, a state where sound collection is performed by the sound input unit 32 may be designated as the sound input reception state, as another specific example of the sound input reception state, i.e., the state where sound input is received to perform sound recognition. In other words, a state where input of sound is received by the sound input unit 32 may be designated as the sound input reception state.

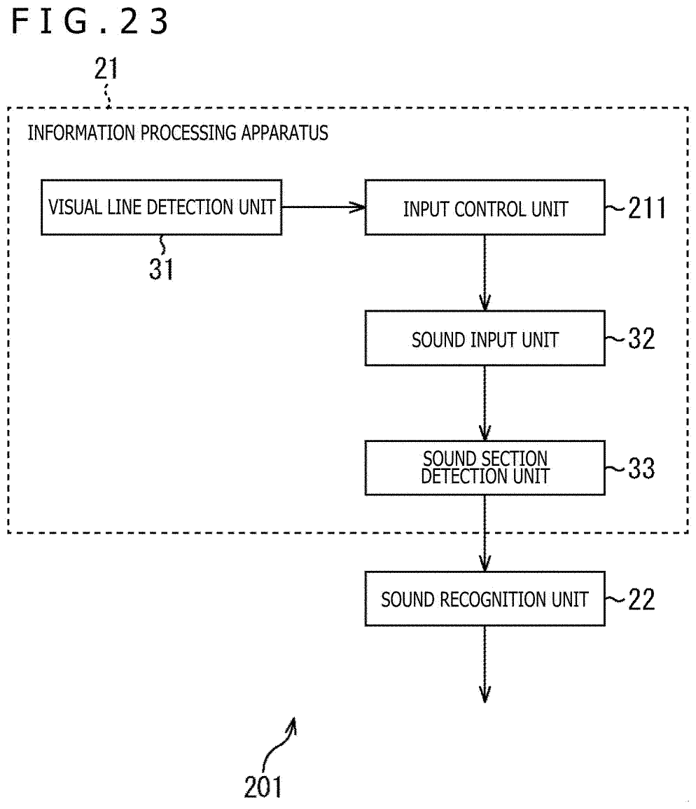

In this case, the sound recognition system is configured as depicted in FIG. 23, for example. Note that parts in FIG. 23 identical to corresponding parts in FIG. 1 are given identical reference signs, and the same description will be omitted where appropriate.

A sound recognition system 201 depicted in FIG. 23 includes the information processing apparatus 21 and the sound recognition unit 22. Moreover, the information processing apparatus 21 includes the visual line detection unit 31, an input control unit 211, the sound input unit 32, and the sound section detection unit 33.

The configuration of the sound recognition system 201 is different from the configuration of the sound recognition system 11 of FIG. 1 in that the input control unit 211 is provided between the visual line detection unit 31 and the sound input unit 32 in place of the input control unit 34, and is same as the sound recognition system 11 of FIG. 1 in other points.

According to the sound recognition system 201, visual line information obtained by the visual line detection unit 31 is supplied to the input control unit 211. The input control unit 211 controls a start and an end of sound collection performed by the sound input unit 32, i.e., reception of input of sound for sound recognition on the basis of the visual line information supplied from the visual line detection unit 31.

The sound input unit 32 collects ambient sound under control by the input control unit 211, and supplies input sound information thus obtained to the sound section detection unit 33. In addition, the sound section detection unit 33 detects an utterance section on the basis of the input sound information supplied from the sound input unit 32, and supplies detected sound information obtained by cutting out the utterance section from the input sound information to the sound recognition unit 22.

### <Description of Sound Recognition Execution Process>

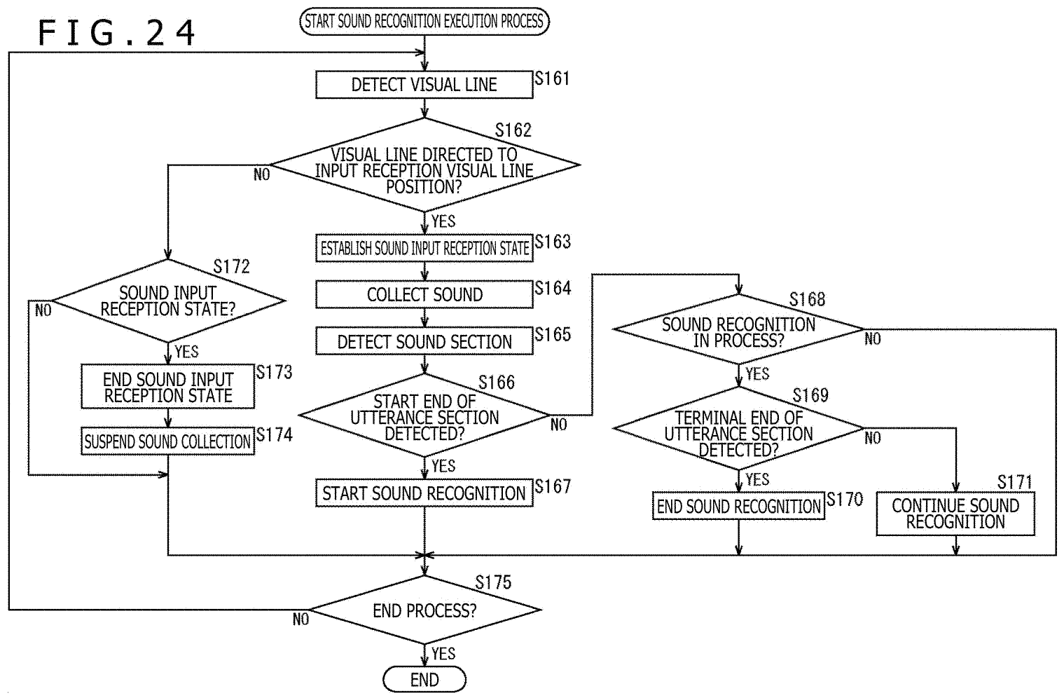

Subsequently, an operation of the sound recognition system 201 will be described. Specifically, a sound recognition execution process performed by the sound recognition system 201 will be hereinafter described with reference to a flowchart of FIG. 24.

In step S161, the visual line detection unit 31 detects a visual line, and supplies visual line information obtained as a result of the detection to the input control unit 211.

In step S162, the input control unit 211 determines whether or not the visual line of the user is directed to an input reception visual line position on the basis of the visual line information supplied from the visual line detection unit 31.

In the case of determination that the visual line of the user is directed to the input reception visual line position in step S162, the input control unit 211 in step S163 establishes the sound input reception state, and instructs the sound input unit 32 to start sound collection. Note that the sound input reception state is maintained in a case where the sound input reception state has been currently established at that time.

In step S164, the sound input unit 32 collects ambient sound, and supplies input sound information thus obtained to the sound section detection unit 33.

In step S165, the sound section detection unit 33 detects a sound section on the basis of the input sound information supplied from the sound input unit 32.

Specifically, the sound section detection unit 33 detects an utterance section in the input sound information by sound section detection. In a case where an utterance section is detected, the sound section detection unit 33 supplies a portion corresponding to the utterance section in the input sound information to the sound recognition unit 22 as detected sound information.

In step S166, the sound recognition unit 22 determines whether or not a start end of the utterance section has been detected on the basis of the detected sound information supplied from the sound section detection unit 33.

For example, the sound recognition unit 22 determines that the start end of the utterance section has been detected in a case where supply of the detected sound information is started from the sound section detection unit 33.

Moreover, in a case where sound recognition is already in process after detection of the start end of the utterance section, or in a case where sound recognition is not performed yet without detection of the start end of the utterance section even in the state of establishment of the sound input reception state, for example, the sound recognition unit 22 determines that the start end of the utterance section has not been detected.

In the case of determination that the start end of the utterance section has been detected in step S166, the sound recognition unit 22 starts sound recognition in step S167.

Specifically, the sound recognition unit 22 performs sound recognition for the detected sound information supplied from the sound section detection unit 33. After the start of sound recognition in this manner, the process proceeds to step S175.

On the other hand, in the case of determination that the start end of the utterance section has not been detected in step S166, the sound recognition unit 22 in step S168 determines whether or not sound recognition is in process.

In the case of determination that sound recognition is not in process in step S168, the process proceeds to step S175 as a result of no supply of the detected sound information to the sound recognition unit 22.

On the other hand, in the case of determination that the sound recognition is in process in step S168, the sound recognition unit 22 in step S169 determines whether or not a terminal end of the utterance section has been detected.

For example, the sound recognition unit 22 determines that the terminal end of the utterance section has been detected in the case of a stop of supply of the detected sound information from the sound section detection unit 33 after continuous supply of the information until this time.

In the case of determination that the terminal end of the utterance section has been detected in step S169, the sound recognition unit 22 ends sound recognition in step S170.

In this case, sound recognition for the entire utterance section detected by sound section detection ends. Accordingly, the sound recognition unit 22 outputs text information obtained as a result of sound recognition.

After completion of sound recognition, the process proceeds to step S175.

In addition, in the case of determination that the terminal end of the utterance section has not been detected in step S169, the process proceeds to step S171.

In step S171, the sound recognition unit 22 continues sound recognition on the basis of the detected sound information supplied from the sound section detection unit 33. After completion of processing in step S171, the process proceeds to step S175.

In steps S166 to S171 described above, the sound recognition unit 22 starts sound recognition in response to a start of supply of detected sound information from the sound section detection unit 33, and ends sound recognition in response to an end of supply of the detected sound information.

In addition, in the case of determination that the visual line of the user is not directed to the input reception visual line position in step S162, the input control unit 211 determines whether or not the sound input reception state has been established in step S172.

In a case where establishment of the sound input reception state is not determined in step S172, the process proceeds to step S175 while skipping processing in step S173 and step S174. In this case, sound collection by the sound input unit 32 is kept suspended.

On the other hand, in the case of determination that the sound input reception state has been established in step S172, the input control unit 211 ends the sound input reception state in step S173.

In this case, the sound input reception state established up until this time is ended in response to a shift of the visual line of the user from the input reception visual line position.

In step S174, the input control unit 211 controls the sound input unit 32 such that sound collection by the sound input unit 32 is suspended.

Specifically, sound collection by the sound input unit 32 is suspended in response to the end of the sound input reception state. Accordingly, sound section detection by the sound section detection unit 33, and sound recognition by the sound recognition unit 22, both performed in a following stage, are suspended.

According to the sound recognition system 201, sound recognition execution control by the sound recognition unit 22 is consequently achieved by controlling a start and an end (suspension) of sound collection by the sound input unit 32 according to whether or not the sound input reception state has been established.

After completion of processing in step S174, the process proceeds to step S175.

In a case where processing in step S167, step S170, step S171, or step S174 is performed, in the case of determination that sound recognition is not in process in step S168, or in the case of determination that the sound input reception state has not been established in step S172, processing in step S175 is performed.

In step S175, the input control unit 211 determines whether to end the process. For example, in a case where an instruction of an operation stop of the sound recognition system 201 is issued, an end of the process is determined in step S175.

In a case where an end of the process is not determined in step S175, the process returns to step S161 to repeat the processing described above.

On the other hand, in a case where an end of the process is determined in step S175, operations of the respective units of the sound recognition system 201 are stopped, and the sound recognition execution process ends.

In the manner described above, the sound recognition system 201 continues the sound input reception state while the visual line of the user is directed to the input reception visual line position. When the visual line of the user is shifted from the input reception visual line position, the sound recognition system 201 ends the sound input reception state. Moreover, the sound recognition system 201 controls the sound input unit 32 such that sound collection is performed in the case of establishment of the sound input reception state.

In this manner, reduction of malfunction of the sound recognition function, and improvement of usability are also achievable by controlling a start and suspension of sound collection according to whether or not the sound input reception state has been established similarly to the case of the sound recognition system 11. Moreover, signal processing such as sound section detection and sound recognition is performed only on necessary occasions by controlling the start and suspension of sound collection according to whether or not the sound input reception state has been established. Accordingly, reduction of power consumption is achievable.

Besides, as described in the fourth embodiment, the sound recognition system 201 may also determine whether to end the sound input reception state according to duration or a cumulative time of a shift of the visual line of the user from an input reception visual line position, a degree of a shift of the visual line of the user from an input reception visual line position, and the like.

### Sixth Embodiment

### <Configuration Example of Sound Recognition System>

Besides, in a case where a plurality of users simultaneously uses the single sound recognition system 11 or the single sound recognition system 201, for example, it is necessary to establish matching between a user directing a visual line to an input reception visual line position and a user giving an utterance to prevent malfunction.

For example, suppose that one of two users who simultaneously use the sound recognition system 11 directs his or her visual line to an input reception visual line position, and that the other user does not direct his or her visual line to the input reception visual line position.

In this case, sound recognition is performed even in a case where the user not directing the visual line to the input reception visual line position gives an utterance unless matching between the user directing the visual line to the input reception visual line position and the user giving the utterance is established.

Accordingly, sound recognition may be performed only when matching is established. Specifically, the input control unit 34 supplies detected sound information to the sound recognition unit 22 and allows execution of sound recognition only when an utterance by the user directing the visual line to the input reception visual line position is specified in the case of detection of the utterance section in the sound input reception state.

Possible methods for establishing matching include a method using a plurality of microphones, and a method utilizing image recognition.

Specifically, according to the method using a plurality of microphones, two microphones are provided on the sound input unit 32 or the like, for example, and a direction in which sound is emitted is specified by beam forming or the like on the basis of sound collected by these microphones.

Moreover, coming directions of respective specified sounds and visual line information associated with the plurality of users located around are temporarily retained, and sound recognition is performed for sound coming in the direction of the user directing the visual line to the input reception visual line position.

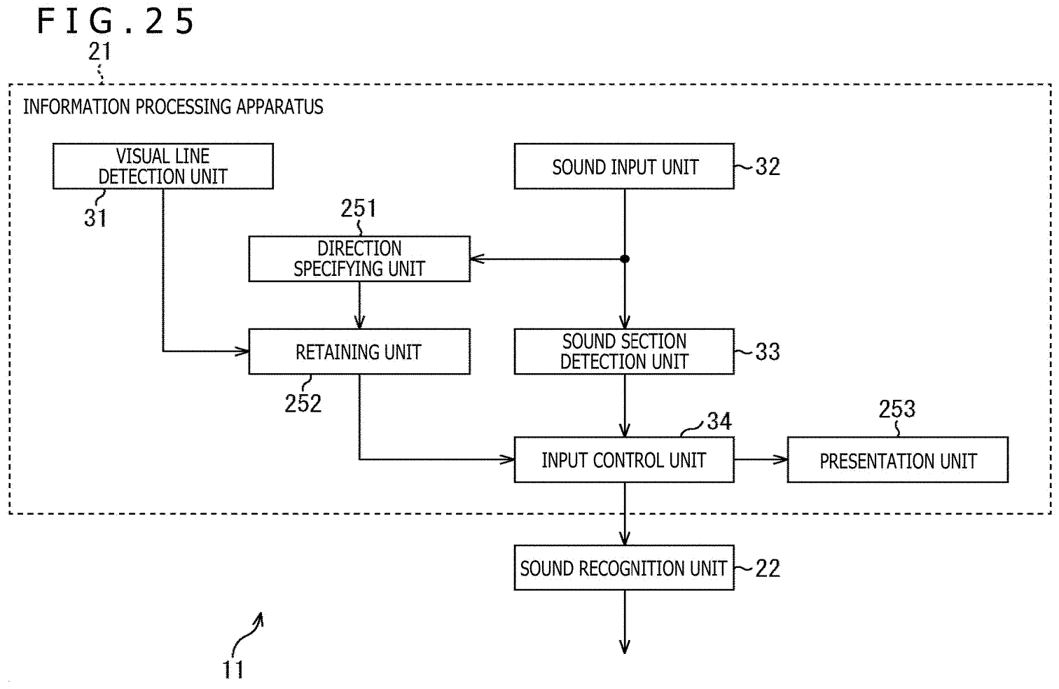

In this case, the sound recognition system 11 is configured as depicted in FIG. 25, for example. Note that parts in FIG. 25 identical to corresponding parts in FIG. 1 are given identical reference signs, and the same description will be omitted where appropriate.

The sound recognition system 11 depicted in FIG. 25 includes the information processing apparatus 21 and the sound recognition unit 22. Moreover, the information processing apparatus 21 includes the visual line detection unit 31, the sound input unit 32, the sound section detection unit 33, a direction specifying unit 251, a retaining unit 252, the input control unit 34, and a presentation unit 253.

A configuration of the sound recognition system 11 depicted in FIG. 25 is produced by newly providing the direction specifying unit 251, the retaining unit 252, and the presentation unit 253 on the sound recognition system 11 depicted in FIG. 1.

According to this example, the sound input unit 32 includes two or more microphones, and supplies input sound information obtained by sound collection to not only the sound section detection unit 33 but also the direction specifying unit 251. Moreover, the visual line detection unit 31 supplies visual line information obtained by visual line detection to the retaining unit 252.

The direction specifying unit 251 specifies coming directions of one or a plurality of sound components contained in input sound information supplied from the sound input unit 32 by beam forming or the like on the basis of the input sound information, supplies a specification result to the retaining unit 252 as sound direction information, and causes the retaining unit 252 to temporarily retain the specification result.

The retaining unit 252 temporarily retains the sound direction information supplied from the direction specifying unit 251 and the visual line information supplied from the visual line detection unit 31, and appropriately supplies the sound direction information and the visual line information to the input control unit 34.

The input control unit 34 is capable of specifying whether the user directing the visual line to the input reception visual line position has given an utterance on the basis of the sound direction information and the visual line information retained in the retaining unit 252.

Accordingly, the input control unit 34 is capable of specifying a rough direction where the user corresponding to the visual line information is located on the basis of the visual line information acquired from the retaining unit 252. In addition, the sound direction information indicates a coming direction of sound of the utterance given by the user.

The input control unit 34 therefore regards that the user directing the visual line to the input reception visual line position has given an utterance in a case where matching is established between the direction of the user specified by the visual line information associated with the user and the coming direction indicated by the sound direction information.

In a case where detected sound information is supplied from the sound section detection unit 33 in the state of establishment of the sound input reception state, the input control unit 34 supplies the detected sound information to the sound recognition unit 22 when specifying that the user directing the visual line to the input reception visual line position has given an utterance.

By contrast, even in a case where the detected sound information is supplied from the sound section detection unit 33 in the state of establishment of the sound input reception state, the input control unit 34 does not supply the detected sound information to the sound recognition unit 22 when obtaining a specification result that the user directing the visual line to the input reception visual line position has not given an utterance.

Note that a direction emphasizing process for emphasizing a sound component coming in the direction from the user directing the visual line to the input reception visual line position may be performed for the input sound information or the detected sound information such that only the detected sound information in an utterance portion of the user directing the visual line to the input reception visual line position is supplied to the sound recognition unit 22.

The sound recognition system 11 further includes the presentation unit 253. For example, the presentation unit 253 includes a plurality of light emitting units such as LEDs (Light Emitting Diodes), and emits light under control by the input control unit 34.

For example, the presentation unit 253 causes some of the plurality of light emitting units to emit light to present indication of the user directing the visual line to the input reception visual line position.

In this case, the input control unit 34 specifies the user directing the visual line to the input reception visual line position on the basis of the visual line information supplied from the retaining unit 252, and controls the presentation unit 253 such that the light emitting unit corresponding to the direction of the user emits light.

Moreover, in a case where matching is established between the user directing the visual line to the input reception visual line position and the user giving an utterance by utilizing image recognition, it is sufficient if the user giving the utterance is specified on the basis of detection of movement of the mouth of the user by image recognition, for example.

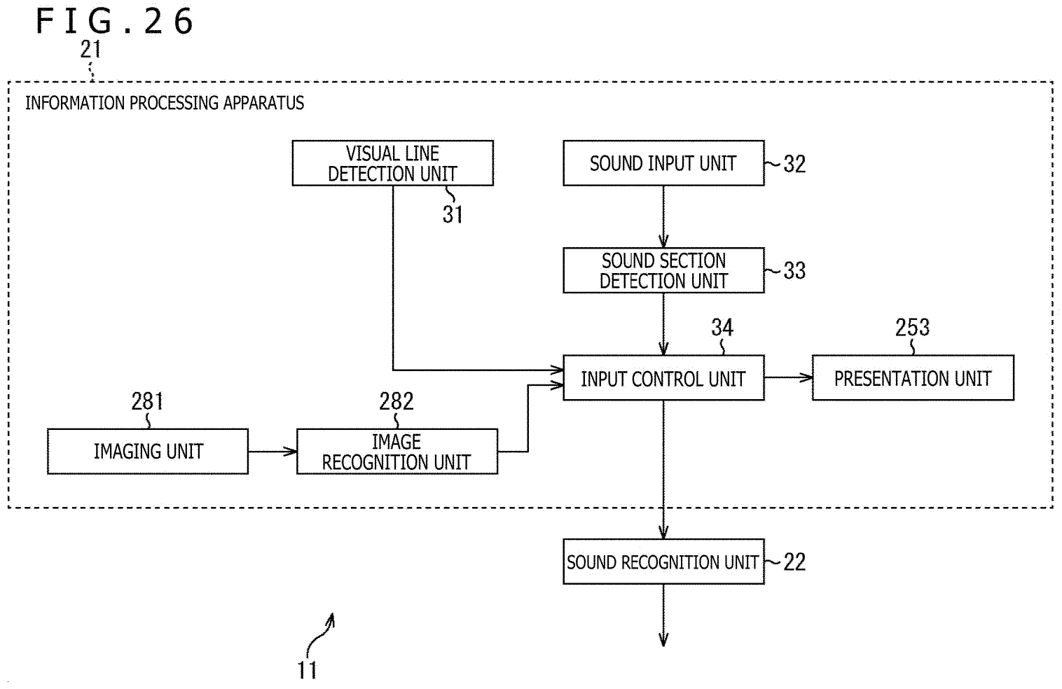

In this case, the sound recognition system 11 is configured as depicted in FIG. 26, for example. Note that parts in FIG. 26 identical to corresponding parts in FIG. 25 are given identical reference signs, and the same description will be omitted where appropriate.

The sound recognition system 11 depicted in FIG. 26 includes the information processing apparatus 21 and the sound recognition unit 22. Moreover, the information processing apparatus 21 includes the visual line detection unit 31, the sound input unit 32, the sound section detection unit 33, an imaging unit 281, an image recognition unit 282, the input control unit 34, and the presentation unit 253.

A configuration of the sound recognition system 11 depicted in FIG. 26 is produced by eliminating the direction specifying unit 251 and the retaining unit 252 from the sound recognition system 11 depicted in FIG. 25, and newly providing the imaging unit 281 and the image recognition unit 282 on the sound recognition system 11 depicted in FIG. 25.

For example, the imaging unit 281 includes a camera or the like, captures an image containing users located around as objects, and supplies the image to the image recognition unit 282. The image recognition unit 282 detects movement of the mouth of each of the users located around by performing image recognition for the image supplied from the imaging unit 281, and supplies a detection result thus obtained to the input control unit 34. Note that the image recognition unit 282 is capable of specifying rough directions of the respective users on the basis of positions of the users contained in the image as objects.

In a case where movement of the mouth of the user directing the visual line to the input reception visual line position is detected on the basis of the detection result supplied from the image recognition unit 282, i.e., the result of image recognition and the visual line information supplied from the visual line detection unit 31, the input control unit 34 specifies that the corresponding user has given an utterance.

In a case where detected sound information is supplied from the sound section detection unit 33 in the state of establishment of the sound input reception state, the input control unit 34 supplies the detected sound information to the sound recognition unit 22 when specifying that the user directing the visual line to the input reception visual line position has given an utterance.

By contrast, even in the case where detected sound information is supplied from the sound section detection unit 33 in the state of establishment of the sound input reception state, the input control unit 34 does not supply the detected sound information to the sound recognition unit 22 when obtaining a specification result that the user directing the visual line to the input reception visual line position has not given an utterance.

Moreover, according to the sound recognition system 11 depicted in each of FIGS. 25 and 26 described above, the presentation unit 253 presents who is the user directing the visual line to the input reception visual line position in the plurality of users.

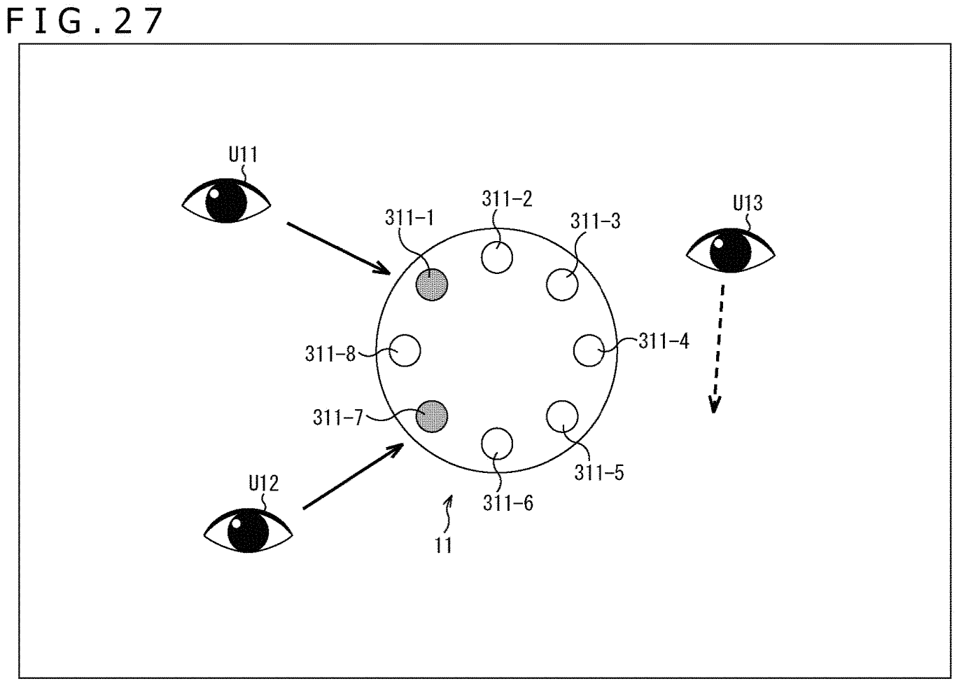

In this case, presentation is given in a manner depicted in FIG. 27, for example.

According to the example depicted in FIG. 27, a plurality of light emitting units 311-1 to 311-8 is provided on the presentation unit 253 of the sound recognition system 11. Each of the light emitting units 311-1 to 311-8 includes an LED, for example.

Note that the light emitting units 311-1 to 311-8 will be hereinafter also simply referred to as light emitting units 311 in a case where distinction between these units is not particularly needed.

According to this example, the eight light emitting units 311 are arranged in a circle. In addition, three users U11 to U13 are present around the sound recognition system 11.

As indicated by arrows in the figure, each of the users U11 and U12 herein directs the visual line in the direction of the sound recognition system 11, while the user U13 directs the visual line in a direction different from the direction of the sound recognition system 11.

Assuming that the position of the sound recognition system 11 is an input reception visual line position, for example, the input control unit 34 causes light emission from only the light emitting units 311-1 and 311-7 located in directions corresponding to directions where the users U11 and U12 facing in the direction of the input reception visual line position are located.

In this manner, each of the users is capable of easily recognizing that each of the users U11 and U12 directs the visual line to the input reception visual line position, and that an utterance of each of the users U11 and U12 is received.

### <Modification>

Meanwhile, while described above is the example which controls a start and an end of the sound input reception state on the basis of only visual line information associated with the user, this control may be achieved in combination with other sound input triggers such as a specific starting word and a starting button.

Specifically, the sound input reception state may be ended in a case where a specific word determined beforehand is uttered after the sound input reception state is established with the visual line of the user directed to an input reception visual line position, for example.

In this case, after establishment of the sound input reception state, the input control unit 34 acquires a sound recognition result from the sound recognition unit 22, and detects an utterance of the specific word given by the user. Thereafter, in a case where an utterance of the specific word is detected, the input control unit 34 ends the sound input reception state.

For ending the sound input reception state on the basis of a specific word in this manner, the sound recognition system 11 performs the input reception control process described with reference to FIG. 22, for example. Thereafter, in a case where an utterance of the specific word is detected, the input control unit 34 determines an end of the sound input reception state in step S125.

In this manner, the user is capable of easily suspending (cancelling) execution of sound recognition without shifting the visual line from the input reception visual line position.

Moreover, a predetermined starting word may be used to assist visual line detection.

In this case, for example, the input control unit 34 or the input control unit 211 starts the sound input reception state on the basis of visual line information and a detection result of the starting word.

Specifically, the sound input reception state may be established when the starting word is detected even in a state of slight deviation of the visual line of the user from the input reception visual line position, for example, as a state for which the sound input reception state is not normally established.

In this manner, malfunction caused by control of the start and the end of the sound input reception state only using the starting word, i.e., malfunction caused by erroneous recognition of the starting word can be reduced. In this case, however, it is necessary to provide, within the information processing apparatus 21, for example, a sound recognition unit which detects only a predetermined starting word from sound information obtained by collecting ambient sound.

Furthermore, according to the example described above, visual line information is used as user direction information to specify whether or not the user directs the visual line to the input reception visual line position, i.e., whether or not the user faces in the direction of the input reception visual line position.

However, the user direction information may be any information as long as the direction of the user is specified, such as information indicating the direction of the face of the user, and information indicating the direction of the body of the user.

In addition, respective items of information such as the visual line information, the information indicating the direction of the face of the user, and the information indicating the direction of the body of the user, may be combined and used as user direction information to specify the direction in which the user faces. In other words, for example, at least any one of the visual line information, the information indicating the direction of the face of the user, or the information indicating the direction of the body of the user may be used as user direction information.

Specifically, for example, the sound input reception state may be established in a case where the input control unit 34 specifies that the user is directing both the visual line and the face to the input reception visual line position.

### Application Example 1

The sound recognition system 11 and the sound recognition system 201 described above are each applicable to a dialog agent system which gives a sound response to present appropriate information for sound input from a user.

This type of dialog agent system uses visual line information associated with the user, for example, to control reception of sound input for performing sound recognition. In this manner, the dialog agent system is configured to respond only to contents of an utterance given to the dialog agent system, and not to respond to surrounding conversation, sound from TV, or the like.

For example, when the visual line of the user is directed to the dialog agent system, an LED attached to the dialog agent system emits light to indicate reception of an utterance, and outputs sound for notification of a reception start. The dialog agent system is designated as an input reception visual line position herein.

When the user recognizes the start of reception, i.e., establishment of the sound input reception state on the basis of the light emission from the LED and the sound for notification of the reception start, the user starts his or her utterance. Suppose herein that the user gives an utterance of “Tell me what the weather is like tomorrow?”

In this case, the dialog agent system performs sound recognition and meaning analysis for the utterance of the user, generates an appropriate response message for a recognition result and an analysis result, and responds by sound. Output herein is sound such as “It will rain tomorrow.”

Moreover, the user gives a subsequent utterance with the visual line kept directed to the dialog agent system. For example, suppose that the user gives an utterance of “What is the weather like weekend?”

In this case, the dialog agent system performs sound recognition and meaning analysis for the utterance of the user, and outputs sound “It will be fine this weekend” as a response message, for example.

Thereafter, the dialog agent system ends the sound input reception state in response to a shift of the visual line of the user from the dialog agent system.

### Application Example 2

Moreover, the sound recognition system 11 and the sound recognition system 201 may each be applied to a dialog agent system so as to operate an apparatus such as TV and a smartphone using the dialog agent system.

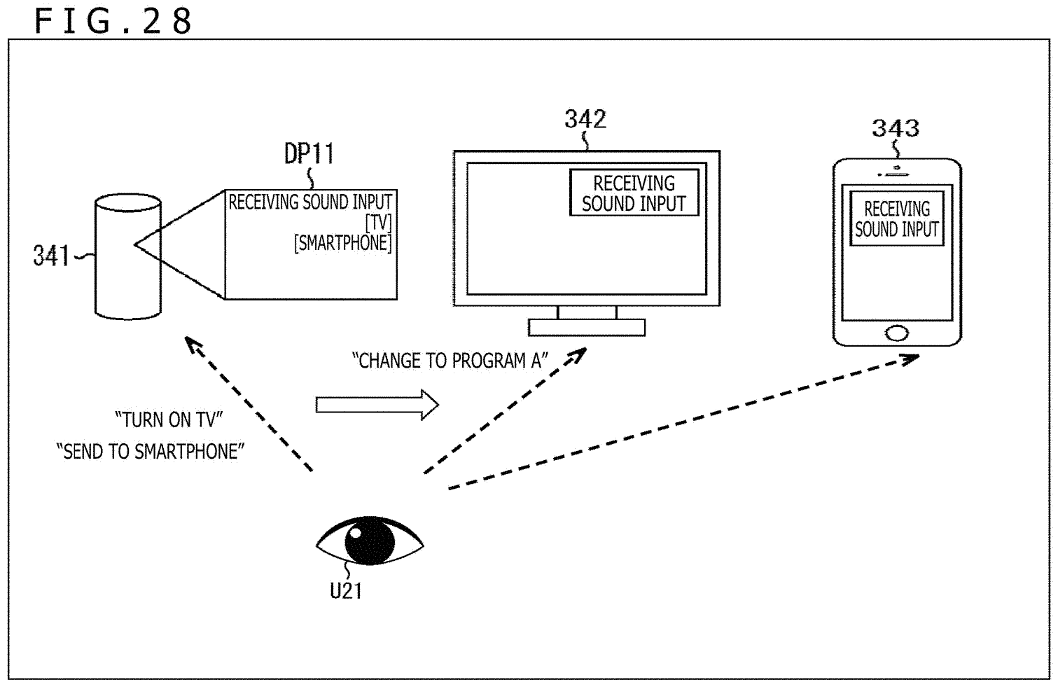

Specifically, as depicted in FIG. 28, suppose that a dialog agent system 341, TV 342, and a smartphone 343 are arranged in a living room or the like where a user U21 is present, and that the dialog agent system 341 through the smartphone 343 operate in linkage with each other, for example.

In this case, for example, the user U21 gives an utterance “Turn on TV” after directing the visual line to the dialog agent system 341 designated as an input reception visual line position. The dialog agent system 341 thus controls the TV 342 in response to the utterance to power on the TV 342 and cause the TV 342 to display a program.

In addition, the dialog agent system 341 simultaneously gives an utterance “receiving sound input by TV,” and adds the position of the TV 342 as an input reception visual line position.

Thereafter, when the user U21 shifts the visual line to the TV 342, characters “receiving sound input” are displayed on the TV 342 in accordance with an instruction from the dialog agent system 341.

In this manner, the user U21 is capable of easily recognizing that the TV 342 is the input reception visual line position on the basis of the display that sound input is received by the TV 342. Moreover, according to this example, characters “receiving sound input” and “TV” indicating that the TV 342 is the input reception visual line position are also displayed on a display screen DP11 of the dialog agent system 341.

Note that a sound message or the like may be output to indicate addition of the TV 342 as the input reception visual line position.

When the TV 342 is added as the input reception visual line position, the state where the dialog agent system 341 receives sound input, i.e., the sound input reception state is maintained as long as the visual line of the user U21 is directed to the TV 342 even in the case of a shift of the visual line from the dialog agent system 341.

When the user U21 gives an utterance “Change to program A” for a change to Program A as a predetermined program name in this state, the dialog agent system 341 and the TV 342 operate in linkage with each other.

For example, the dialog agent system 341 gives a response “changing to 4ch” to the utterance of the user U21, and controls the TV 342 for channel switching to a channel corresponding to Program A to display Program A on the TV 342. In this example, Program A is provided on 4-channel. Accordingly, an utterance “changing to 4ch” is given to the user U21.

Subsequently, after an elapse of a fixed time without utterance by the user U21, the display of the characters “receiving sound input” on the TV 342 disappears, and the dialog agent system 341 ends reception of sound input. In other words, the sound input reception state ends.

Furthermore, suppose that the user U21 again directs the visual line to the dialog agent system 341, and gives an utterance “Send recommended restaurant information to smartphone.”

In this case, the dialog agent system 341 establishes the sound input reception state, and gives an utterance “Transmission of recommended restaurant information to smartphone is completed. Sound input is received by smartphone” as a response message for the utterance of the user.

Thereafter, the dialog agent system 341 operates in linkage with the smartphone 343 similarly to the case of the TV 342.

At this time, the dialog agent system 341 adds the position of the smartphone 343 as an input reception visual line position, and displays characters “receiving sound input” on the smartphone 343. Moreover, the dialog agent system 341 displays characters “smartphone” on the display screen DP11 of the dialog agent system 341 to indicate that the smartphone 343 is an input reception visual line position.

In this manner, the state that the dialog agent system 341 continuously receives sound input, i.e., the sound input reception state is maintained even in the case of a shift of the visual line of the user U21 to the smartphone 343.

Moreover, in this case, detection of the visual line of the user U21 is switched to detection performed by the smartphone 343, and the dialog agent system 341 acquires visual line information from the smartphone 343. Furthermore, the dialog agent system 341 ends reception of sound input at timing of an end of the use of the smartphone 343 by the user U21, such as at timing of turning off the display screen of the smartphone 343 by the user U21. In other words, the sound input reception state ends.

### Application Example 3

Furthermore, the sound recognition system 11 and the sound recognition system 201 are each applicable to a robot having dialogs with a plurality of users.

For example, consider a case of dialogs between one robot to which the sound recognition system 11 or the sound recognition system 201 is applied, and a plurality of users.

This type of robot has a plurality of microphones. The robot is capable of specifying coming directions of sounds uttered by the users on the basis of input sound information obtained by collecting sound using the microphones.

In addition, the robot constantly analyzes visual line information associated with the users, and is capable of responding only to an uttered sound coming from the user facing the robot.

Accordingly, the robot is capable of responding only to an utterance given to the robot, and responding to only this utterance of the user without responding to a conversation between the users.

According to the present technology described above, appropriate sound recognition execution control is achievable by establishing the sound input reception state or ending the sound input reception state on the basis of a direction of a user.

Particularly, the present technology is capable of controlling a start and an end of sound input in a natural manner by utilizing the direction of the user such as a visual line of the user without the necessity of an utterance of a starting word from the user and the use of a physical mechanism such as a button.

Moreover, a start of sound input, i.e., a start of sound recognition against an intension of the user, caused in such a case where the user temporarily directs the visual line by accident, for example, can be reduced by ending the sound input reception state on the basis of the direction of the user.

Besides, as in the fourth embodiment, for example, sound input can be continued even at the time of a shift of the visual line of the user from a predetermined apparatus of a plurality of apparatuses to another apparatus by maintaining the sound input reception state in a case where the visual line of the user is located between two input reception visual line positions.

In addition, according to the sixth embodiment, an utterance to be recognized is limited to only an utterance of a user directing his or her visual line to an input reception visual line position in a case where a plurality of users uses a sound recognition system to which the present technology is applied.

Needless to say, the respective embodiments and modifications described above may be combined in appropriate manners.

### <Configuration Example of Computer>

Meanwhile, a series of processes described above may be executed either by hardware or by software. In a case where the series of processes is executed by software, a program constituting the software is installed in a computer. Examples of the computer herein include a computer incorporated in dedicated hardware, and a computer capable of executing various functions under various programs installed in the computer, such as a general-purpose personal computer.

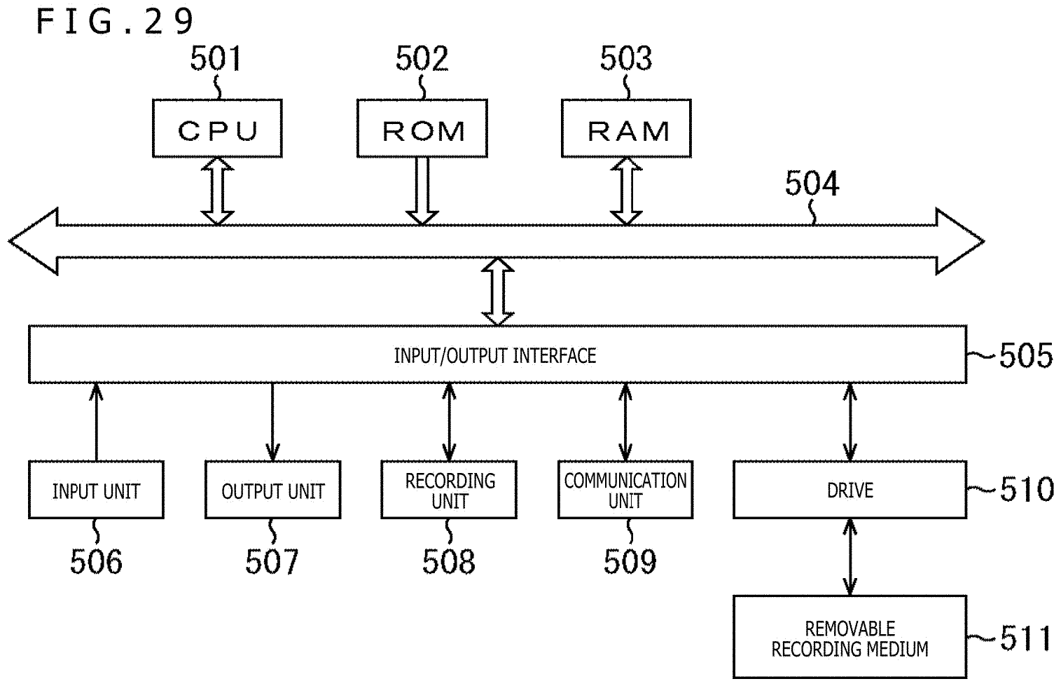

FIG. 29 is a block diagram depicting a configuration example of hardware of a computer executing the series of processes described above under a program.

In the computer, a CPU (Central Processing Unit) 501, a ROM (Read Only Memory) 502, and a RAM (Random Access Memory) 503 are connected to each other via a bus 504.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element, and the like. The output unit 507 includes a display, a speaker, and the like. The recording unit 508 includes a hard disk, a non-volatile memory, and the like. The communication unit 509 includes a network interface and the like. The drive 510 drives a removable recording medium 511 such as a magnetic disk, an optical disk, a magneto-optical disk, and a semiconductor memory.

According to the computer configured as above, the CPU 501 loads a program recorded in the recording unit 508 into the RAM 503 via the input/output interface 505 and the bus 504, and executes the loaded program to perform the series of processes described above, for example.

The program executed by the computer (CPU 501) is allowed to be recorded in the removable recording medium 511 such as a package medium, and provided in this form. Alternatively, the program is allowed to be provided via a wired or wireless transfer medium, such as a local area network, the Internet, and digital satellite broadcasting.

According to the computer, the program is allowed to be installed in the recording unit 508 via the input/output interface 505 from the removable recording medium 511 attached to the drive 510. Alternatively, the program is allowed to be received by the communication unit 509 via a wired or wireless transfer medium, and installed in the recording unit 508. Instead, the program is allowed to be installed in the ROM 502 or the recording unit 508 beforehand.

Note that the program executed by the computer may be a program where processes are performed in time series in an order described in the present description, or may be a program where processes are performed in parallel, or at necessary timing such as at an occasion of a call.

Furthermore, embodiments of the present technology are not limited to the embodiments described above, but may be modified in various manners without departing from the scope of the subject matters of the present technology.

For example, the present technology is allowed to have a configuration of cloud computing where one function is shared and processed by a plurality of apparatuses in cooperation with each other via a network.

Moreover, the respective steps described in the above flowcharts are allowed to be executed by one apparatus, or shared and executed by a plurality of apparatuses.

Furthermore, in a case where one step contains a plurality of processes, the plurality of processes contained in the one step is allowed to be executed by one apparatus, or shared and executed by a plurality of apparatuses.

In addition, the present technology is allowed to have following configurations.

(1)

An information processing apparatus including:
a control unit that ends a sound input reception state on the basis of user direction information indicating a direction of a user.
   (2)

The information processing apparatus according to (1), in which the control unit controls a start and an end of the sound input reception state on the basis of the user direction information.

(3)

The information processing apparatus according to (1) or (2), in which the control unit ends the sound input reception state in a case where a predetermined condition based on the user direction information is met.

(4)

The information processing apparatus according to (3), in which the control unit regards that the predetermined condition is met in a case where the user does not face in a direction of a specific position.

(5)

The information processing apparatus according to (3), in which the control unit regards that the predetermined condition is met in a case where duration or a cumulative time of a state where the user does not face in a direction of a specific position exceeds a threshold after a start of the sound input reception state.

(6)

The information processing apparatus according to (3), in which the control unit regards that the predetermined condition is met in a case where deviation between a direction in which the user faces and a direction of a specific position exceeds a threshold.

(7)

The information processing apparatus according to (3), in which the control unit regards that the predetermined condition is met in a case where a direction in which the user faces is neither any one of a plurality of directions of specific positions, nor a direction located between two of the specific positions.

(8)

The information processing apparatus according to (3), further including:
a presentation unit that gives presentation that a direction of the user deviates from a direction of a specific position.
   (9)

The information processing apparatus according to any one of (2) to (8), in which the control unit establishes the sound input reception state in a case where the user faces in a direction of a specific position.

(10)

The information processing apparatus according to (9), in which one or a plurality of positions is designated as the specific position.

(11)

The information processing apparatus according to (10), in which the control unit adds or deletes a position designated as the specific position.

(12)

The information processing apparatus according to any one of (1) to (11), in which the control unit starts sound recognition when an utterance section is detected from sound information obtained by sound collection in a case where the sound input reception state has been established.

(13)

The information processing apparatus according to (12), further including:
a buffer that retains the sound information, in which the control unit starts the sound recognition when the utterance section is detected from the sound information retained in the buffer in the case where the sound input reception state has been established.
   (14)

The information processing apparatus according to (12) or (13), in which the control unit starts the sound recognition when the user facing in a direction of a specific position gives an utterance in a case where the utterance section has been detected in the sound input reception state.

(15)

The information processing apparatus according to (14), in which the control unit specifies whether the user facing in the direction of the specific position has given an utterance on the basis of an image recognition result for an image containing the user located in a sound coming direction or located around as an object, and on the basis of the user direction information.

(16)

The information processing apparatus according to any one of (1) to (11), in which the control unit causes a sound input unit to collect ambient sound in a case where the sound input reception state has been established.

(17)

The information processing apparatus according to any one of (2) to (8), in which the control unit causes the sound input reception state to be started on the basis of the user direction information, and a detection result of a predetermined word from sound information indicating collected sound.

(18)

The information processing apparatus according to any one of (1) to (17), in which the user direction information includes at least any one of visual line information associated with the user, information indicating a direction of a face of the user, or information indicating a direction of a body of the user.

(19)

An information processing method performed by an information processing apparatus, the information processing method including:

ending a sound input reception state on the basis of user direction information indicating a direction of a user.

(20)

A program that causes a computer to execute processing including:
a step of ending a sound input reception state on the basis of user direction information indicating a direction of a user.

### REFERENCE SIGNS LIST

11: Sound recognition system
21: Information processing apparatus
22: Sound recognition unit
31: Visual line detection unit
32: Sound input unit
33: Sound section detection unit
34: Input control unit

1. An information processing apparatus comprising:
a control unit that ends a sound input reception state on a basis of user direction information indicating a direction of a user.

2. The information processing apparatus according to claim 1, wherein the control unit controls a start and an end of the sound input reception state on the basis of the user direction information.

3. The information processing apparatus according to claim 1, wherein the control unit ends the sound input reception state in a case where a predetermined condition based on the user direction information is met.

4. The information processing apparatus according to claim 3, wherein the control unit regards that the predetermined condition is met in a case where the user does not face in a direction of a specific position.

5. The information processing apparatus according to claim 3, wherein the control unit regards that the predetermined condition is met in a case where duration or a cumulative time of a state where the user does not face in a direction of a specific position exceeds a threshold after a start of the sound input reception state.

6. The information processing apparatus according to claim 3, wherein the control unit regards that the predetermined condition is met in a case where deviation between a direction in which the user faces and a direction of a specific position exceeds a threshold.

7. The information processing apparatus according to claim 3, wherein the control unit regards that the predetermined condition is met in a case where a direction in which the user faces is neither any one of a plurality of directions of specific positions, nor a direction located between two of the specific positions.

8. The information processing apparatus according to claim 3, further comprising:
a presentation unit that gives presentation that a direction of the user deviates from a direction of a specific position.

9. The information processing apparatus according to claim 2, wherein the control unit establishes the sound input reception state in a case where the user faces in a direction of a specific position.

10. The information processing apparatus according to claim 9, wherein one or a plurality of positions is designated as the specific position.

11. The information processing apparatus according to claim 10, wherein the control unit adds or deletes a position designated as the specific position.

12. The information processing apparatus according to claim 1, wherein the control unit starts sound recognition when an utterance section is detected from sound information obtained by sound collection in a case where the sound input reception state has been established.

13. The information processing apparatus according to claim 12, further comprising:
a buffer that retains the sound information,
wherein the control unit starts the sound recognition when the utterance section is detected from the sound information retained in the buffer in the case where the sound input reception state has been established.

14. The information processing apparatus according to claim 12, wherein the control unit starts the sound recognition when the user facing in a direction of a specific position gives an utterance in a case where the utterance section has been detected in the sound input reception state.

15. The information processing apparatus according to claim 14, wherein the control unit specifies whether the user facing in the direction of the specific position has given an utterance on a basis of an image recognition result for an image containing the user located in a sound coming direction or located around as an object, and on the basis of the user direction information.

16. The information processing apparatus according to claim 1, wherein the control unit causes a sound input unit to collect ambient sound in a case where the sound input reception state has been established.

17. The information processing apparatus according to claim 2, wherein the control unit causes the sound input reception state to be started on a basis of the user direction information, and a detection result of a predetermined word from sound information indicating collected sound.

18. The information processing apparatus according to claim 1, wherein the user direction information includes at least any one of visual line information associated with the user, information indicating a direction of a face of the user, or information indicating a direction of a body of the user.

19. An information processing method performed by an information processing apparatus, the information processing method comprising:
ending a sound input reception state on a basis of user direction information indicating a direction of a user.

20. A program that causes a computer to execute processing comprising:
a step of ending a sound input reception state on a basis of user direction information indicating a direction of a user.
